(19) United States
(12) Patent Application Publication
(10) Pub. No.: US 2026/0183691 A1
(43) Pub. Date: Jul. 2, 2026

(54) MULTI-LOFTED FILTER

(71) Applicants: Jeffrey Herbert CHESEBROUGH, Cambridge (CA); John Garnet CHESEBROUGH, Bowmanville (CA)

(72) Inventors: Jeffrey Herbert CHESEBROUGH, Cambridge (CA); John Garnet CHESEBROUGH, Bowmanville (CA)

(21) Appl. No.: 19/008,203

(22) Filed: Jan. 2, 2025

(51) Int. Cl. B01D 46/62; B01D 39/20; B01D 46/00; B01D 46/52

(52) U.S. Cl. CPC B01D 46/62; B01D 39/2003; B01D 46/0001; B01D 46/0005; B01D 46/0032; B01D 46/521; B01D 2265/04; B01D 2267/40

(57) ABSTRACT

In an aspect, there is provided an air filter consumable configured for accommodating charge distribution features associated with an air filter housing. The air filter consumable may include a passive filter media. The passive filter media includes a first filtering region and a second filtering region having a relatively thinner loft than the first filtering region.

### TECHNICAL FIELD

The present application relates to filters for removing impurities from air and, more particularly, to electronic air filters which polarize air-borne particles to facilitate the trapping of such particles.

### BACKGROUND

A shortcoming of many powered air filter pads is their inability to perform when powered in an airflow where the particulate presented to the filter contains a significant amount of carbon. For this reason, such filters typically cannot obtain a certified Minimum Efficiency Reporting Value (MERV) rating from The American Society of Heating, Refrigerating and Air-Conditioning Engineers (ASHRAE) when they are powered.

Passive filters, which are non-powered filters, also have shortcomings. For example, many passive filters have limited capability to filter particulate that is smaller than 0.3 microns in size. Most of the particles in indoor air are smaller than 0.3 microns in size. For example, smog, smoke, suspended atmospheric dust, viruses, soot and some gaseous contaminants are less than 0.3 microns in size. Many passive filters are ill-suited for filtering such particles.

Further, modern air quality challenges, such as traffic related air pollution (TRAP) and black carbon (BC) from forest fires, require filters having improved performance capabilities. Thus, there is a need for improved filters and improved filter assemblies.

### BRIEF DESCRIPTION OF THE DRAWINGS

Embodiments are described in detail below, with reference to the following drawings:

FIG. 1 is a perspective view of an electronic air cleaner in accordance with an example embodiment;

FIG. 2 is an enlarged perspective view of a corner of the electronic air cleaner of FIG. 1, showing a fastening tab in a locked position;

FIG. 3 is an enlarged perspective view of a corner of the electronic air cleaner of FIG. 1, showing a fastening tab in an unlocked position;

FIG. 4 is a front plan view of an exterior side of a first part of a filter housing of the electronic air cleaner of FIG. 1;

FIG. 5 is a front plan view of an exterior side of a second part of a filter housing of the electronic air cleaner of FIG. 1;

FIG. 6 is a front plan view of an interior side of a first part of a filter housing of the electronic air cleaner of FIG. 1;

FIG. 7 is a front plan view of an interior side of a second part of the filter housing of the electronic air cleaner of FIG. 1;

FIG. 8 is an enlarged plan view of the interior side of the first part of the filter housing of the electronic air cleaner of FIG. 1 showing a non-conductive protector;

FIG. 9 is an enlarged side view of the second part of the filter housing of the electronic air cleaner of FIG. 1;

FIG. 10 is a side elevational view of a filter media which may be used in the electronic air cleaner of FIG. 1;

FIG. 11 is a front plan view of the filter media of FIG. 10;

FIG. 12 is a rear plan view of the filter media of FIG. 10;

FIG. 13 is a bottom side plan view of the filter media of FIG. 10;

FIG. 14 is a front plan view of the filter media of FIG. 10 in which an active filter media is peeled back from a passive filter media to show internal portions of the filter media;

FIG. 15 is a side plan view of the filter media of FIG. 10 in which the active filter media is peeled back from a passive filter media to show internal portions of the filter media;

FIG. 16 is a front plan view of an internal side of the active filter media of the filter media of FIG. 14 which is shown detached from the passive filter media;

FIG. 17 is a front perspective view of the air cleaner of FIG. 1 showing the filter media partially inserted into the filter housing;

FIG. 18 is a front perspective view of the air cleaner of FIG. 1 showing the filter media inserted into the filter housing at a part of the filter housing;

FIG. 19 is a perspective view of an example air cleaner and furnace;

FIG. 20 is a perspective view of a further example air cleaner;

FIG. 21 is a front plan view of the interior of the first side of the filter housing of another embodiment of an electronic air cleaner with a probe shaped as a bar extending laterally;

FIG. 22 is a front plan view of the exterior of the first side of the filter housing of another embodiment of an electronic air cleaner with a probe shaped as a bar extending laterally;

FIG. 23 is a tilted perspective view of a filter media in which an active filter media is peeled back from a passive filter media made up of two different pleated parts with different loft heights to show internal portions of the filter media placed in the filter housing from FIG. 21;

FIG. 24 is a side view of a filter media from FIG. 23 in which an active filter media is peeled back from a passive filter media made up of two different pleated parts with different loft heights;

FIG. 25 is a front plan view of the filter media from FIG. 23 in which an active filter media is peeled back from a passive filter media made up of two different pleated parts with different loft heights;

FIG. 26 is a side elevational view of the filter media from FIG. 23 in which an active filter media is peeled back from a passive filter media made up of two different pleated parts with different loft heights;

FIG. 27 is a front plan view of an example electronic air cleaner embodiment where a filter media from FIG. 23 is being placed into the filter housing from FIG. 21;

FIG. 28 is a front plan view of the example electronic air cleaner embodiment where a filter media from FIG. 23 is placed into the cavity of the filter housing from FIG. 21, with the active filter media pulled back to show the internal placements;

FIG. 29 is a side perspective view of the example electronic air cleaner embodiment where a filter media from FIG. 23 is placed into the cavity of the filter housing from FIG. 21, with the active filter media pulled back to show the internal placements;

FIG. 30 is a front plan view of the example electronic air cleaner embodiment where a filter media from FIG. 23 is placed into the cavity of the filter housing from FIG. 21;

FIG. 31 is a back plan view of the example electronic air cleaner embodiment where a filter media from FIG. 23 is placed into the cavity of the filter housing from FIG. 21;

FIG. 32 is a perspective view of an example electronic air cleaner embodiment with a probe and a passive filter media with two different pleated parts with different loft heights;

FIG. 33 is a side view of an example electronic air cleaner embodiment with a probe and a passive filter media with two different pleated parts with different loft heights;

FIG. 34 is a side view of an example passive filter media which is made from two different pleated parts with different loft heights;

FIG. 35 is a front plan view of an example passive filter media which is made from two different pleated parts with different loft heights; and

FIG. 36 is a side elevation view of an example passive filter media which is made from two different pleated parts with different loft heights.

Like reference numerals are used in the drawings to denote like elements and features.

### DETAILED DESCRIPTION OF EXAMPLE EMBODIMENTS

In one aspect, the present application describes an air filter consumable configured for accommodating charge distribution features associated with an air filter housing. The air filter consumable may include a passive filter media. The passive filter media may include a first filtering region and a second filtering region having a relatively thinner loft than the first filtering region.

In at least some implementations, the first filtering region and the second filtering region may be non-conductive air-permeable pleated filtering mediums.

In at least some implementations, the first filtering region and the second filtering region may be coupled together with an adhesive.

In at least some implementations, the first filtering region and the second filtering region may be coupled together such that a first side of the first filtering region and a first side of the second filtering region are planar. The first side of the first filtering region and the first side of the second filtering region may be perpendicular to a coupling region of the first filtering region and the second filtering region.

In at least some implementations, a second side of the first filtering region and a second side of the second filtering region form a step.

In at least some implementations, the air filter consumable may further include an active filter media.

In at least some implementations, the active filter media may have a uniform loft across its area.

In at least some implementations, the active filter media may be a non-pleated filter media.

In at least some implementations, the active filter media may be a dielectric filter medium. The dielectric filter medium may be a permeable glass pad.

In at least some implementations, the active filter media may be coupled to the passive filter media with an adhesive at the first filtering region but not the second filtering region.

In at least some implementations, the active filter media may include conductive filaments for distributing a charge from a region of the active filter media associated with the second filtering region to a region of the active filter media associated with the first filtering region.

In at least some implementations, the active filter media may be relatively more compressible than the passive filter media.

In at least some implementations, the active filter media and the passive filter media may define a pocket therebetween in an area associated with the second filtering region. The pocket may be for accommodating the charge distribution features.

In at least some implementations, a loft height of the active filter media may be between a half of an inch (0.5″) to three quarters of an inch (0.75″). A loft height of a second filtering region may be between a half of an inch (0.5″) and three quarters of an inch (0.75″). The loft height of the first filtering region may be between three quarters of an inch (0.75″) to one and a half inch (1.5″).

In at least some implementations, the first filtering region and the second filtering region may be pleated regions formed using a gluing technique in which an adhesive bonds adjacent pleats together at intervals.

In at least some implementations, the second filtering region may have a loft that is at least one centimeter less than the loft of the first filtering region.

In another aspect, an air filter is described. The air filter may include an air filter consumable described herein. The air filter may include an air filter housing. The air filter housing may define a cavity that houses the air filter consumable.

In another aspect, a method of manufacturing an air filter consumable is described. The method may include preparing a passive filter media by coupling a first filtering region to a second filtering region with an adhesive. The second filtering region may have a relatively thinner loft than the first filtering region.

In at least some implementations, coupling the first filtering region and the second filtering region may include aligning a first side of the first filtering region and a first side of the second filtering region such that the first side of the first filtering region and the first side of the second filtering region are planar. The first side of the first filtering region and the first side of the second filtering region may be perpendicular to a coupling region of the first filtering region and the second filtering region.

In at least some implementations, coupling the first filtering region and the second filtering region may include forming a step at a point of contact between the first filtering region and the second filtering region.

In at least some implementations, the method may further include coupling an active filter media to the passive filter media with an adhesive.

In at least some implementations, coupling the active filter media to the passive filter media with the adhesive may further include coupling the passive filter media at the first filtering region but not the second filtering region.

In at least some implementations, the active filter media may have a uniform loft across its area.

In at least some implementations, the active filter media may be a non-pleated filter media. In at least some implementations, the active filter media may be a glass pad.

In at least some implementations, the method may include, prior to coupling the active filter media to the passive filter media with the adhesive, coupling conductive filaments to the active filter media. The conductive filaments may be configured for distributing a charge from a region of the active filter media associated with the second filtering region to a region of the active filter media associated with the first filtering region.

In at least some implementations, the active filter media may be relatively more compressible than the passive filter media.

In at least some implementations, a loft height of the active filter media may be between a half of an inch (0.5″) to three quarters of an inch (0.75″). A loft height of a second filtering region may be between a half of an inch (0.5″) and three quarters of an inch (0.75″) and the loft height of the first filtering region may be between three quarters of an inch (0.75″) to one and a half inch (1.5″).

In at least some implementations, the active filter media and the passive filter media may define a pocket therebetween in an area associated with the second filtering region. The pocket may be for accommodating charge distribution features.

In at least some implementations, the method may include, prior to coupling a first filtering region to a second filtering region with an adhesive: pleating the first filtering region using a gluing technique in which an adhesive bonds adjacent pleats together at intervals; and pleating the second filtering region using a gluing technique.

In at least some implementations, the second filtering region may have a loft that is at least one centimeter less than the loft of the first filtering region.

In another aspect, a hybrid pad set for providing concurrent active and passive filtering in an air filter housing is described. The hybrid pad set may include a non-pleated active filter media. The hybrid pad set may include a pleated passive filter media. The pleated passive filter media may be constructed of a nano-engineered material.

In at least some implementations, the nano-engineered material has a substantially uniform grid-like structure. In at least some implementations, the nano-engineered material has a substantially uniform structure under microscope. In at least some implementations, the nano-engineered material is engineered to include fibers in a range of 100 nm to 200 nm. In at least some implementations, the nano-engineered material is engineered to include fibers in a range of 100 nm to 1000 nm. In at least some implementations, the pleated passive filter media is constructed of a three-dimensional network of stacked nanofibers. In at least some implementations, the pleated passive filter media is constructed of a nano-engineered material configured to collect particles 10 microns or less in size.

In at least some implementations, the pleated passive filter media may be coupled with the non-pleated active filter media using an adhesive. In at least some implementations, the adhesive couples the pleated passive filter media to the non-pleated active filter media at only a portion of a surface of each of the pleated passive filter media and the non-pleated active filter media such that an uncoupled region of the non-pleated active filter media is movable relative to the pleated passive filter media.

In at least some implementations, the hybrid pad set may further include a tab coupled to the pleated passive filter media at an end. The tab may protrude above the pleated passive filter media to a region associated with the non-pleated active filter media. The tab may be for facilitating removal of the pleated passive filter media from the air filter housing.

In at least some implementations, the hybrid pad set further includes conductive filaments for distributing a charge across a surface of the non-pleated active filter media. In at least some implementations, the conductive filaments are coupled to a surface of the non-pleated active filter media with an adhesive.

In at least some implementations, the passive filter media may be pleated using a gluing technique in which an adhesive bonds adjacent pleats together at intervals.

In at least some implementations, the non-pleated active filter media and the pleated passive filter media are sized to concurrently fit within a two inch filter housing. In at least some implementations, the non-pleated active filter media and the pleated passive filter media are sized to concurrently fit within a one inch filter housing. In at least some implementations, the non-pleated active filter media and the pleated passive filter media are sized to concurrently fit within a four inch filter housing. In at least some implementations, the non-pleated active filter media and the pleated passive filter media are sized to concurrently fit within a five inch filter housing.

In another aspect, an air filter is described. The air filter may include a hybrid pad set described herein. The air filter may also include an air filter housing that defines a cavity that houses the hybrid pad set.

In another aspect, a ventilation system is described. The ventilation system includes a housing, such as a duct, defining a slot for receiving an air filter. An air filter of a type described herein may be situated in the slot and oriented to allow the non-pleated active filter media to form an inlet side of the air filter and the pleated passive filter media to form an outlet side of the air filter.

In yet another aspect, there is described a method of manufacturing a hybrid pad set. The method may include coupling a non-pleated active filter media to a pleated passive filter media with an adhesive. The pleated passive filter media may be constructed of a nano-engineered material.

In at least some implementations of the method, the nano-engineered material has a substantially uniform grid-like structure. In at least some implementations, the nano-engineered material has a substantially uniform structure under microscope. In at least some implementations, the nano-engineered material is engineered to include fibers in a range of 100 nm to 1000 nm. In at least some implementations, the pleated passive filter media is constructed of a three-dimensional network of stacked nanofibers. In at least some implementations, the pleated passive filter media is constructed of a nano-engineered material configured to collect particles 10 microns or less in size.

In at least some implementations, the adhesive couples the pleated passive filter media to the non-pleated active filter media at only a portion of a surface of each of the pleated passive filter media and the non-pleated active filter media such that an uncoupled region of the non-pleated active filter media is movable relative to the pleated passive filter media.

In at least some implementations, the method may further include coupling a tab to the pleated passive filter media at an end. The tab may protrude above the passive filter media to a region associated with the non-pleated active filter media. The tab may facilitate removal of the passive filter media from an air filter housing.

In at least some implementations, the method may include, prior to coupling a passive filter media to an active filter media with an adhesive, coupling conductive filaments to a surface of the active filter media with an adhesive. The conductive filaments may be configured for distributing a charge across the surface of the active filter media.

In at least some implementations, the passive filter media may be pleated using a gluing technique in which an adhesive bonds adjacent pleats together at intervals.

In at least some implementations, the non-pleated active filter media and the pleated passive filter media are sized to concurrently fit within a two inch filter housing. In at least some implementations, the non-pleated active filter media and the pleated passive filter media are sized to concurrently fit within a one inch filter housing. In at least some implementations, the non-pleated active filter media and the pleated passive filter media are sized to concurrently fit within a four inch filter housing. In at least some implementations, the non-pleated active filter media and the pleated passive filter media are sized to concurrently fit within a five inch filter housing.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of ...or...” is intended to cover any one or more of the listed elements, including any one of the listed elements alone, any sub-combination, or all of the elements, without necessarily excluding any additional elements, and without necessarily requiring all of the elements.

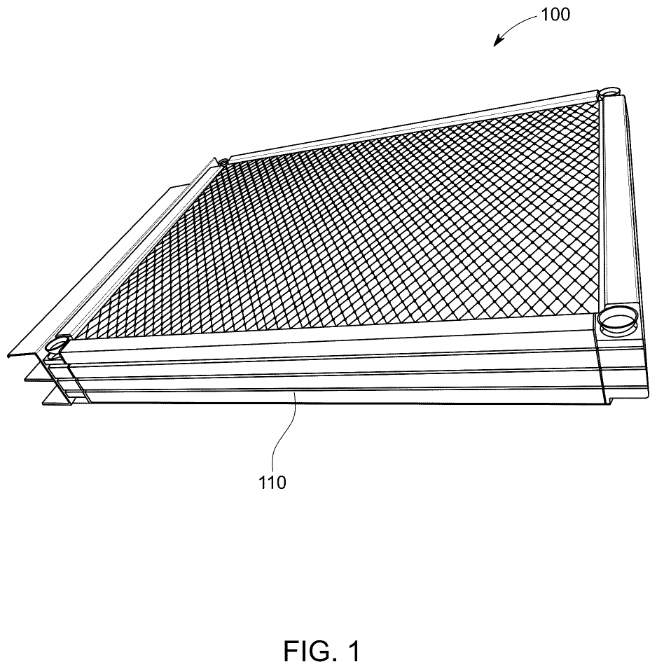

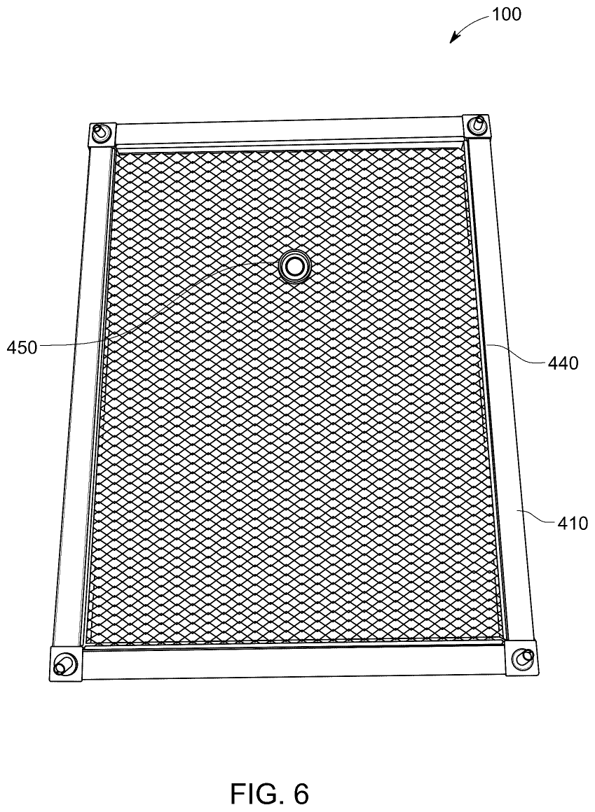

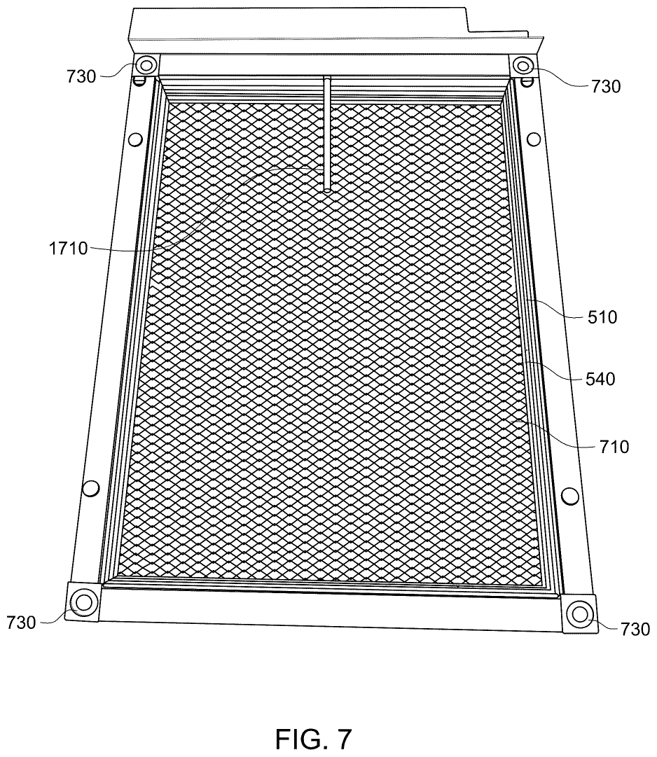

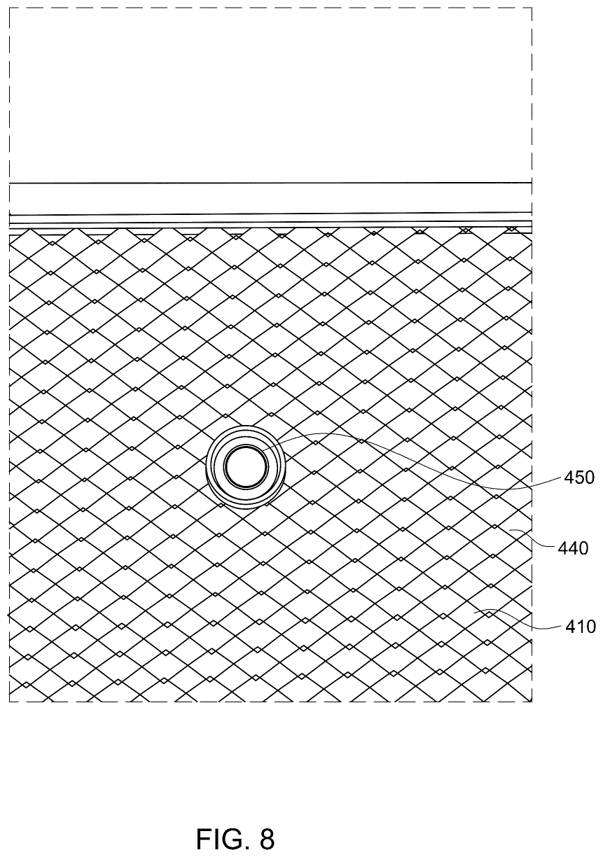

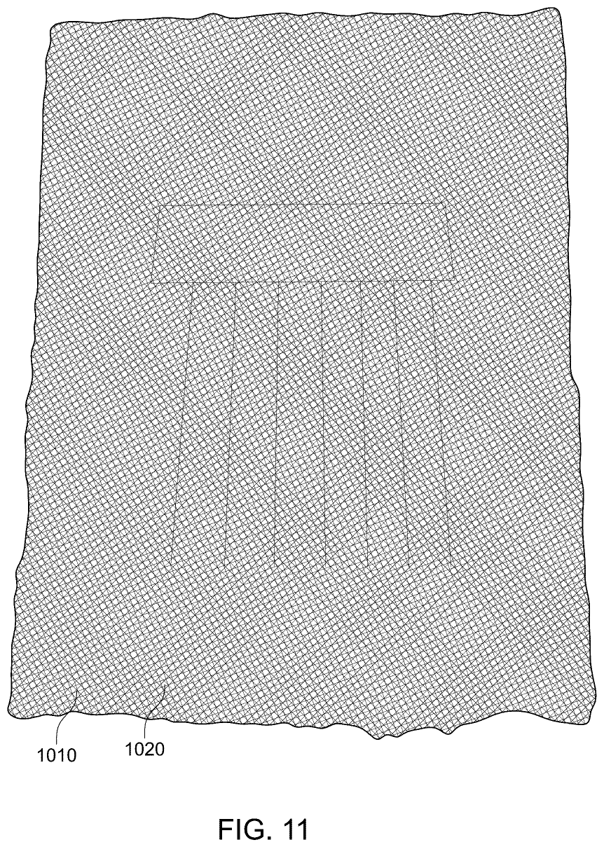

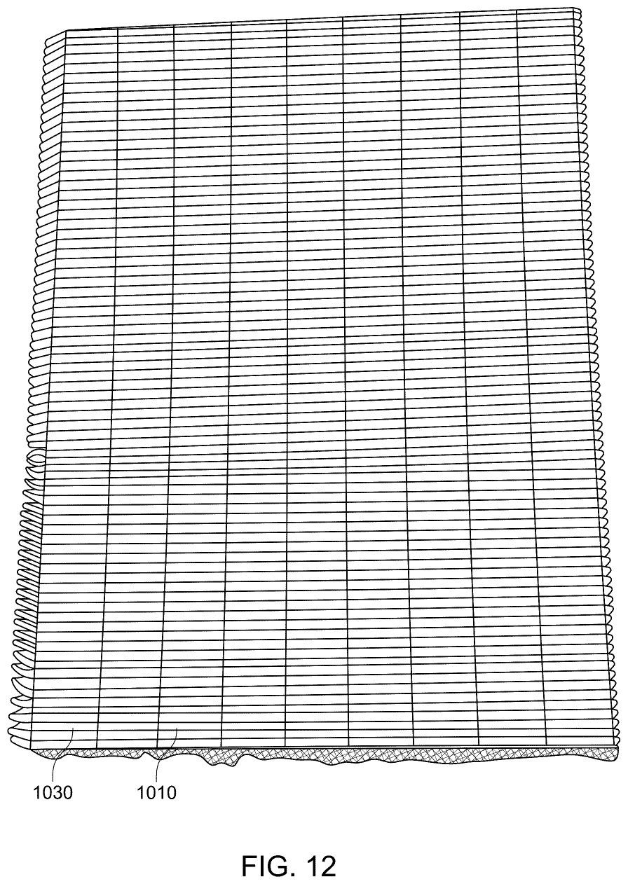

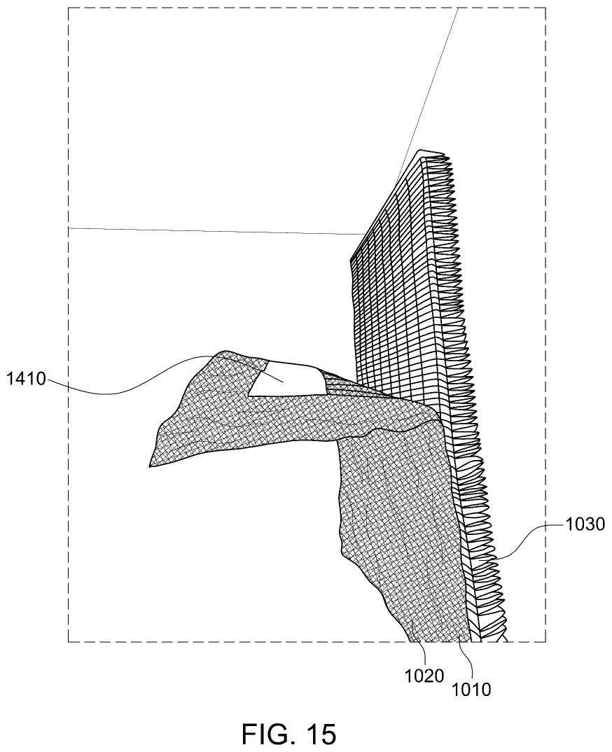

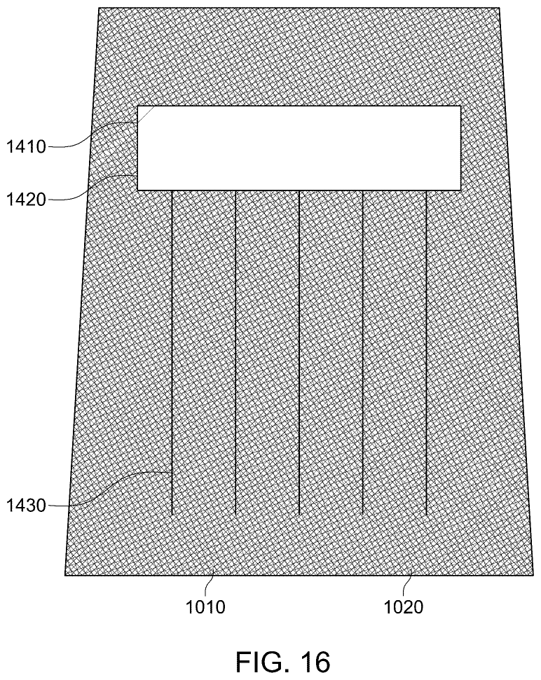

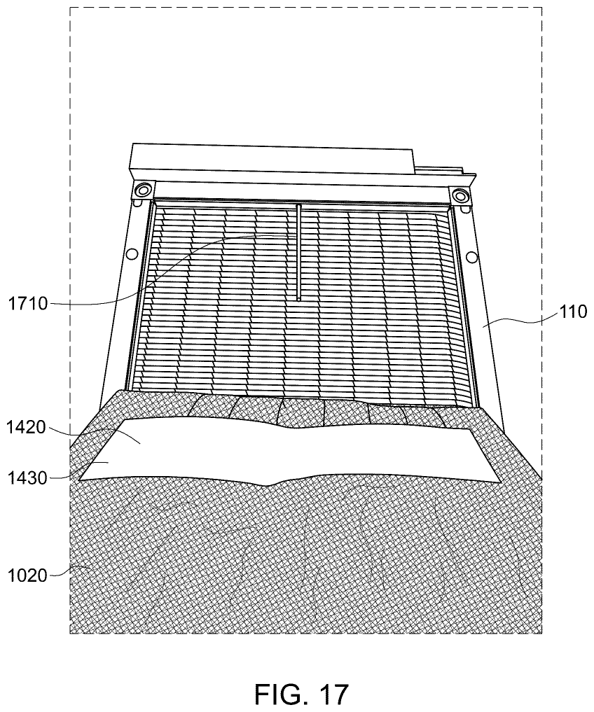

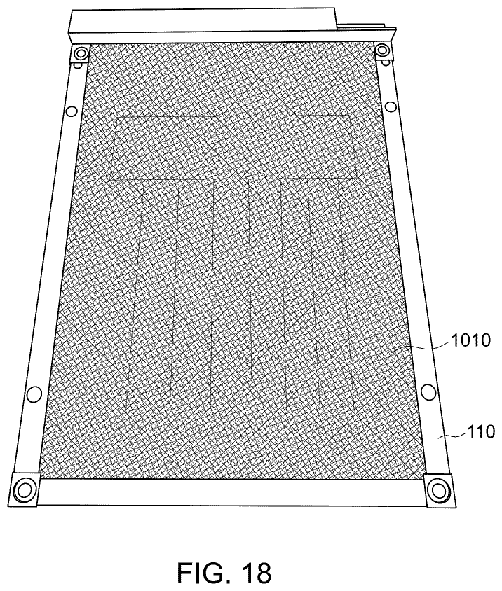

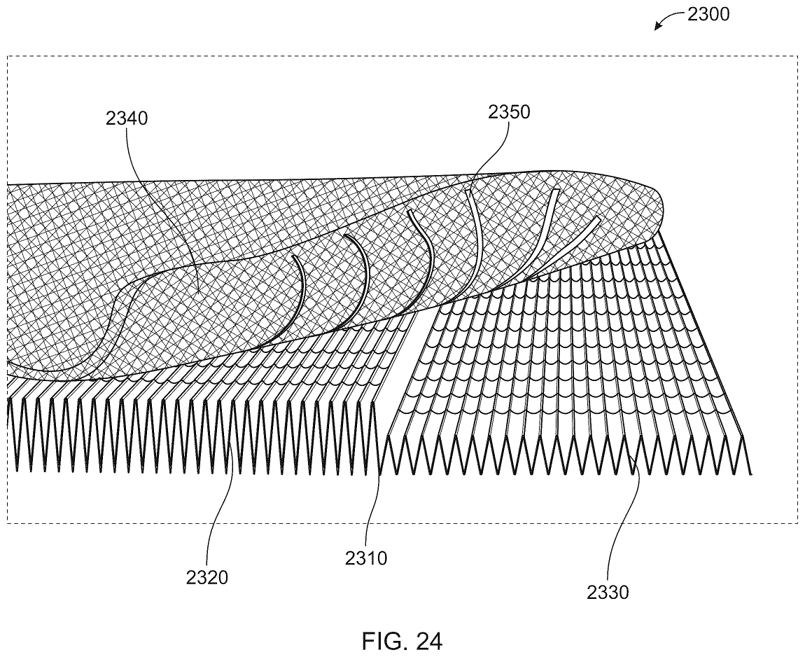

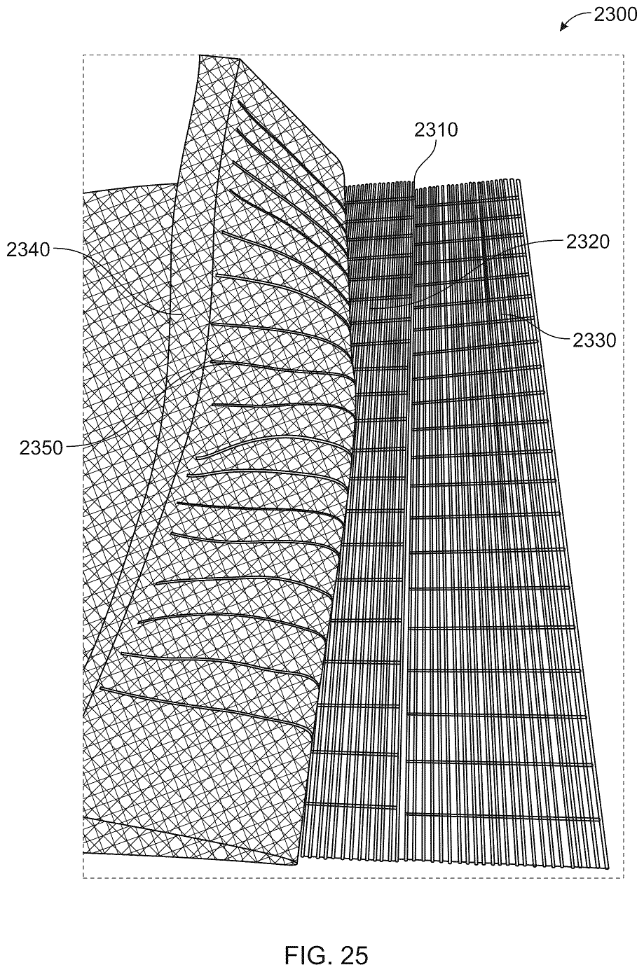

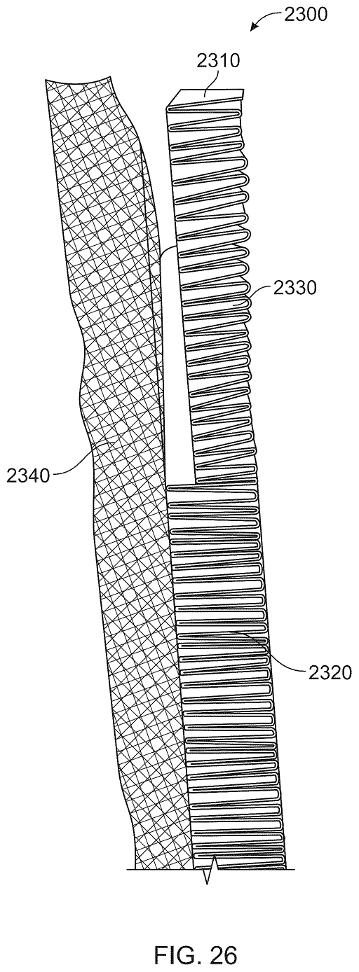

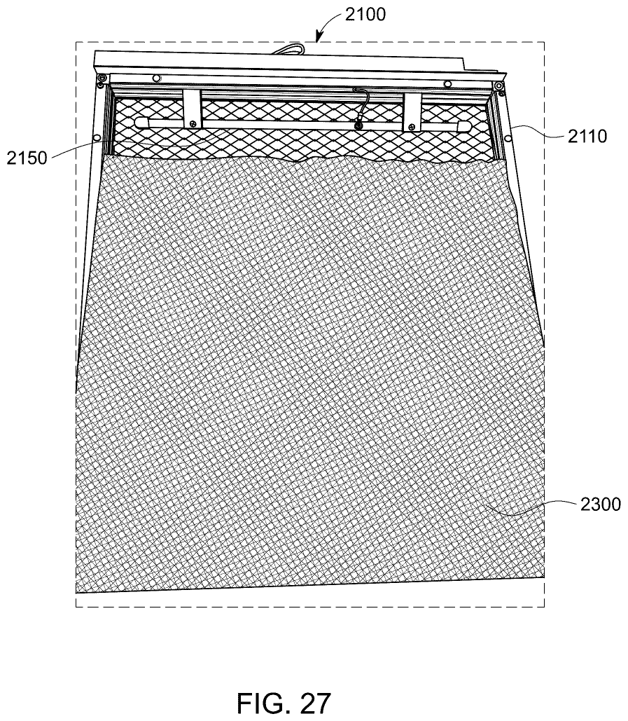

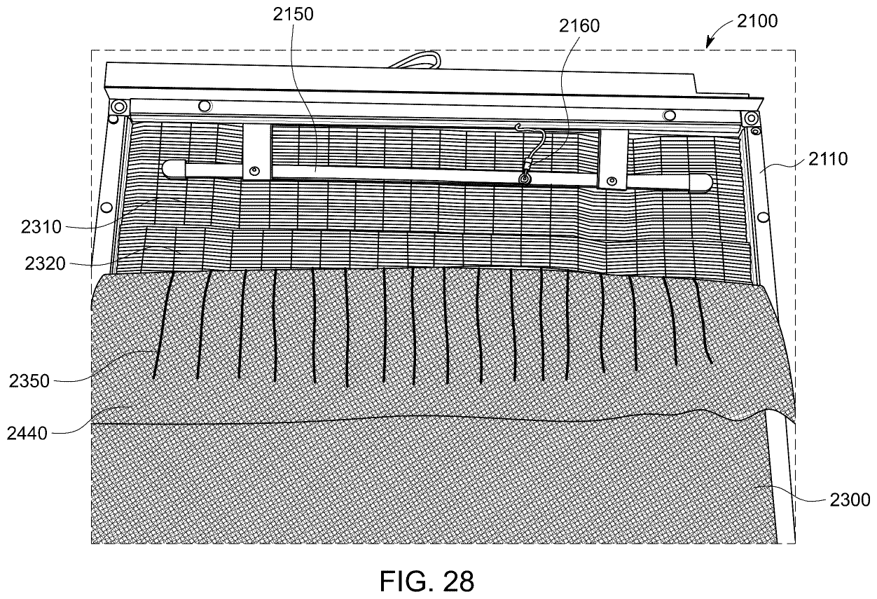

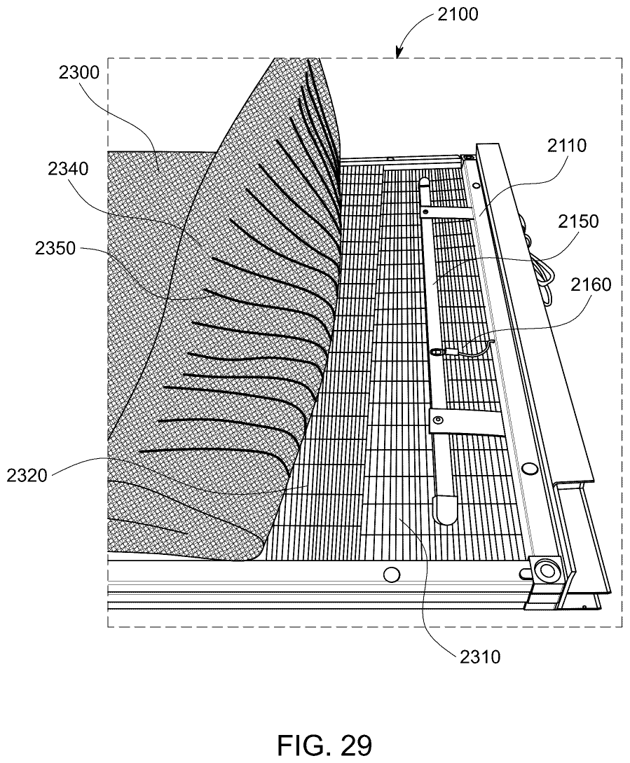

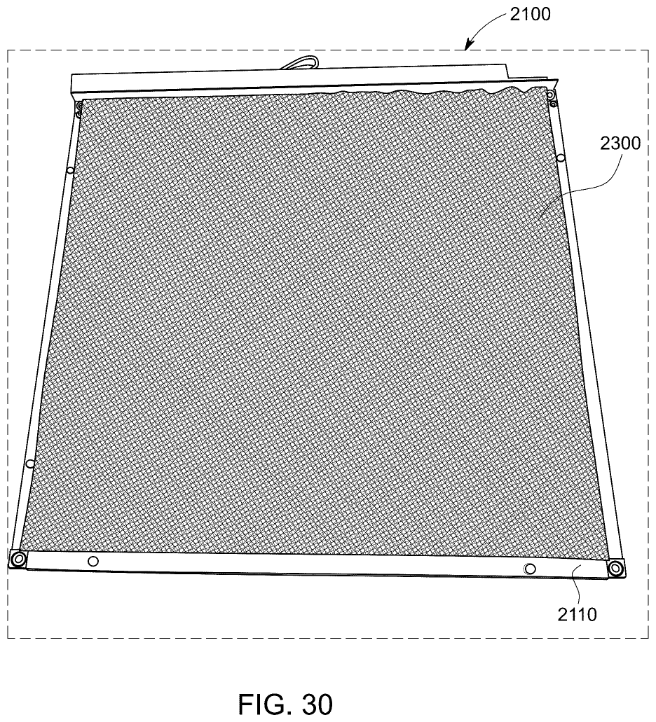

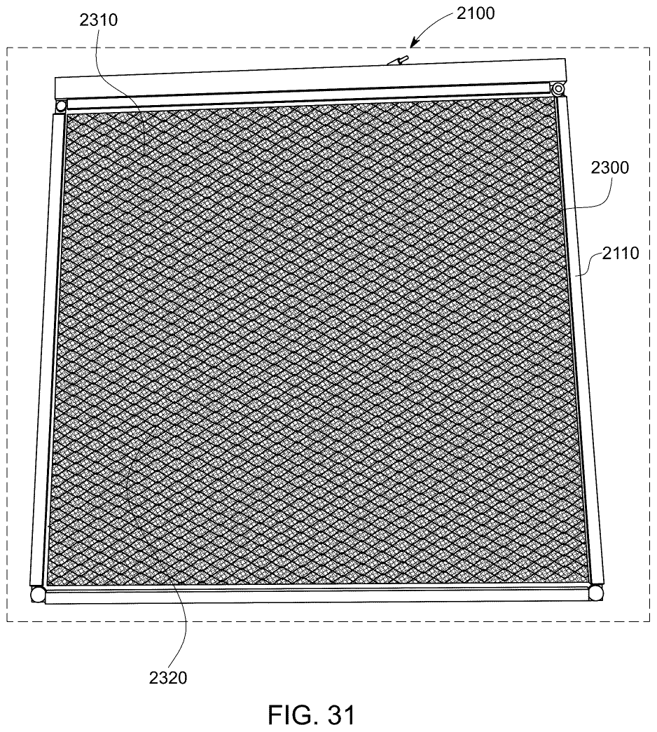

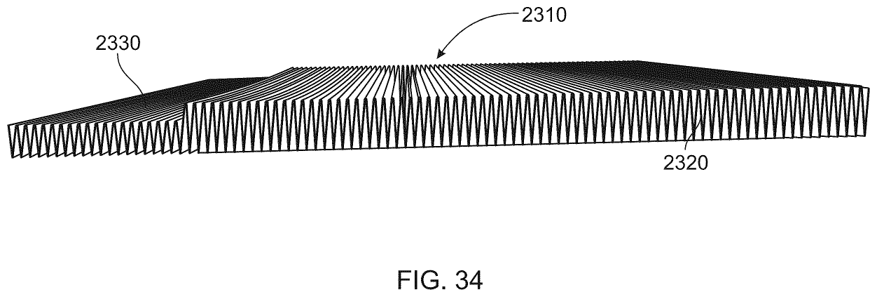

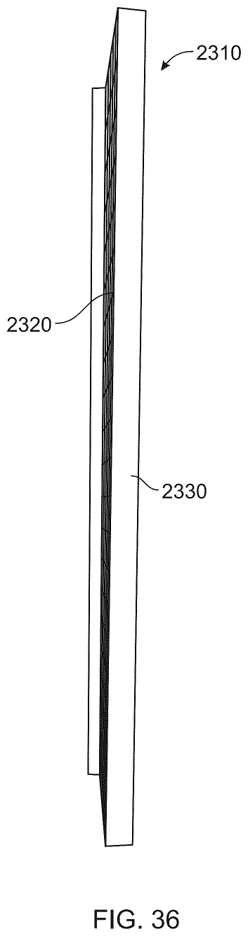

The present disclosure relates to electronic air cleaners, examples of which are illustrated in FIGS. 1 to 36. Reference will first be made to FIGS. 1 to 18, which illustrate a first example of an electronic air cleaner 100. The electronic air cleaners 100 described herein use a two-part filter media. In the example of FIGS. 1 to 18, this filter media has a generally consistent thickness throughout. This is in contrast to other implementations described herein, which use a multi-lofted passive filter.

The electronic air cleaners 100 described herein may also be referred to as one or more of: a powered filter, an electronic filter, a filter, an electronic filter assembly, a powered filter assembly, an electrostatic air cleaner, an electrostatic filter assembly, an electrostatic filter, an electronic polarization filter, an electronic polarization air cleaner, an air filter an HVAC filter, a furnace filter and/or an electronic polarization filter assembly.

The electronic air cleaner 100 may be generally rectangular in shape, such as a rectangular prism. The electronic air cleaner 100 may have exterior dimensions that are sized to allow the filter to fit within a filter slot or compartment of a forced air system.

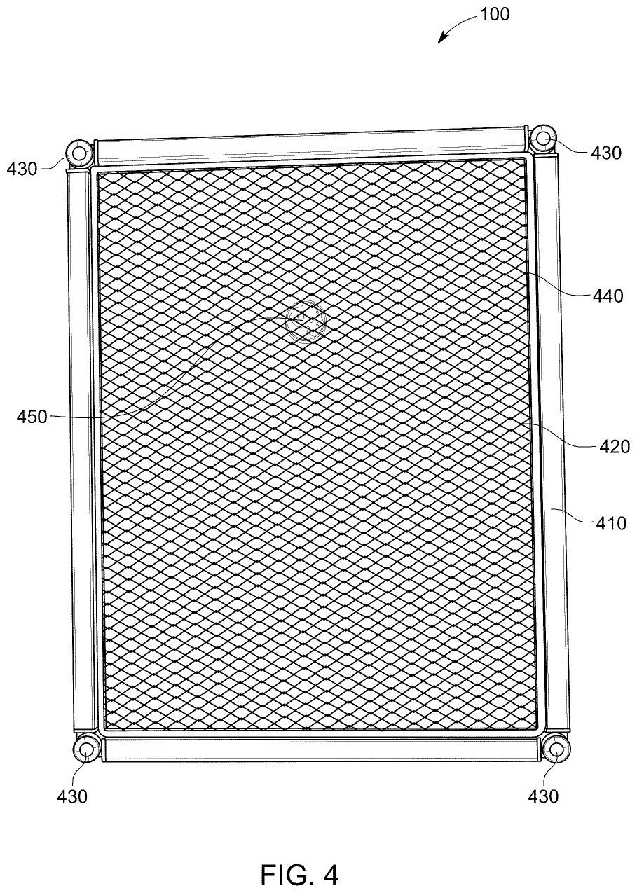

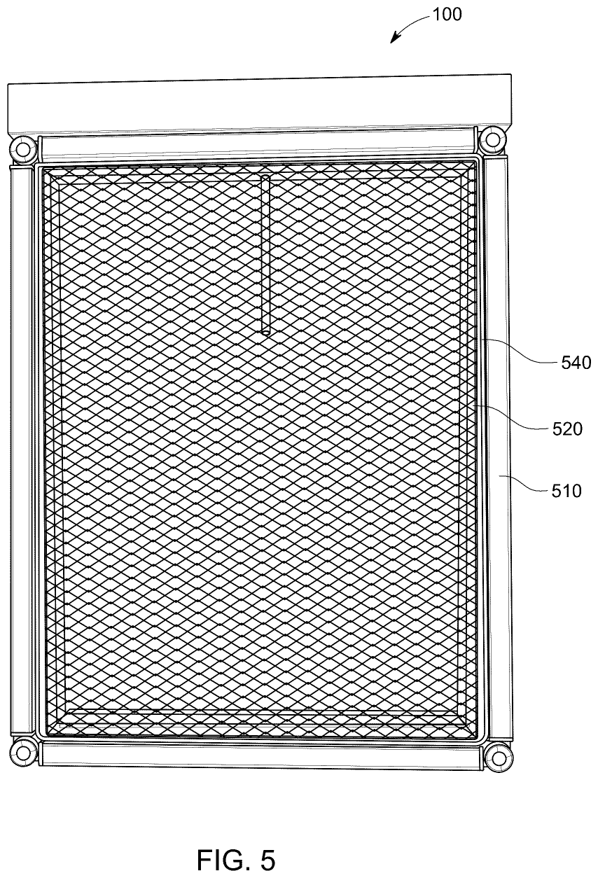

The electronic air cleaner 100 may include a filter housing 110, which may also be referred to as a filter cage or filter holder. This filter housing 110 may be used to house filter media 1010 (examples of which are illustrated in FIGS. 10 to 18). The filter housing 110 may define a cavity 710 (FIG. 7) which receives the filter media 1010. The filter housing 110 may open to allow the filter media 1010 to be received within the filter cavity 710. For example, the filter housing 110 may be two-part. A first part 410 (FIG. 4) may include a first face 420 and a second part 510 (FIG. 5) may include a second face 520. The filter housing 110 may be reusable and the filter cavity 710 may be consumable.

As illustrated in FIGS. 4 to 7, the first part 410 may be detachable from the second part 510. A latch, clasp or other mechanism may maintain the filter housing 110 in a closed position and it may be disengaged in order to allow the filter housing 110 to be opened to remove or insert the filter media 1010.

In the illustrated example, as shown in FIGS. 4 to 7, the first part 410 and the second part 510 may be completely detachable from one another. The first part 410 and the second part 510 may be connected to one another using fasteners 430 (FIG. 4) which may be situated at respective corners of the filter housing 110. For example, snap tabs may be used to connect the parts to one another at respective corners. One of the parts, such as the first part 410, may have respective fasteners 430, such as tabs, which may be pushed in the direction of the second part 510 in order to couple the parts together or it may be pulled in the opposite direction to detach the parts from one another. In the example illustrated, the fasteners 430 are located at the corners of the first part 410. One or more of the parts may have slots 730 (FIG. 7) for receiving the fasteners 430. For example, the first part 410 may have the fasteners 430 and the second part may have the slots 730. The fasteners 430 and the slots 730 may have mating features, such as corresponding ridges and recesses or protrusions and voids, which allow the fasteners 430 and slots 730 to snap together. Once coupled together, the fasteners 430 may be removed by applying a force to decouple the mating features.

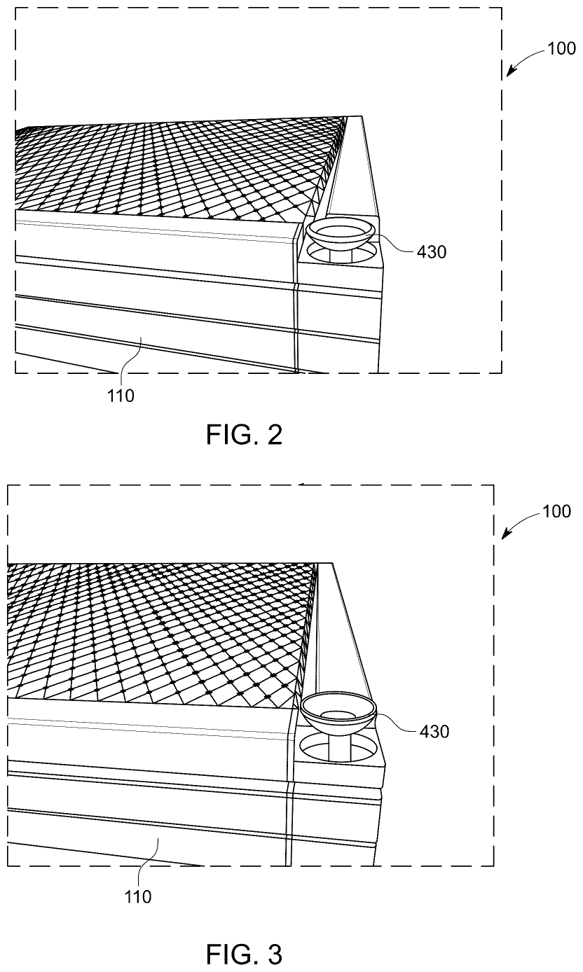

FIGS. 2 and 3 illustrate how the fasteners 430 may be used to couple the two parts to one another. In FIG. 2, the fastener 430 is shown in an engaged position in which the fastener 430 is downward so that it is engaging a slot 730 in order to couple the first part 410 to the second part 510. In FIG. 3, the fastener 430 is shown in a disengaged position in which the fastener 430 does not engage the slot 730 so that the first part 410 is no longer coupled to the second part 510. When each of the fasteners 430 is in the position of FIG. 3, the parts may be separated from one another in order to, for example, insert or change the filter media 1010.

In the illustrated example, when the fasteners 430 are in the engaged position illustrated in FIG. 2, the external surface is substantially flush with other portions of the external face of the filter housing 110. When the fasteners 430 are in the engaged position, they do not protrude beyond the external surface of the filter housing 110. This arrangement prevents the fasteners 430 from creating an obstacle that might impede insertion within a slot associated with a forced air system.

The filter parts may be coupled to one another in other ways in other implementations. For example, in some implementations, the first part 410 may not be completely detached from the second part 510. Instead, the first part 410 may be connected to the second part 510 at respective edges with a hinge. A clasp may be engaged to maintain the filter housing 110 in the closed position by preventing movement of the hinge. The clasp may be disengaged to allow the filter housing to be opened.

The respective first and second parts 410, 510 of the filter housing 110 may also be referred to as screens or grills. The first and second parts 410, 510 may include respective screened surfaces 440, 540 (FIGS. 4 and 5) which allow air to flow through such surfaces. In the example illustrated, the screened surfaces 440, 540 have diamond screens, though other screening arrangements are possible.

The filter housing 110 may be constructed of a rigid material such as metal. In some implementations, the filter housing 110 may be constructed of aluminum.

The filter media 1010 (illustrated in FIGS. 10 to 18) may also be referred to as a filter pad or a pad or as an air filter consumable or as a hybrid pad set. The filter media 1010 is a multi-material filter media. The filter media 1010 may include both active filter media 1020 and passive filter media 1030. The filter media may also be referred to as filtering media. The active filter media 1020 may be used as an upstream filter media and the passive filter media 1030 may be used as a downstream filter media. That is, the active filter media 1020 may be situated within the filter housing 110 so that it is relatively more upstream than the passive filter media 1030. Put differently, the filter media 1010 is situated so that incoming air flow enters the electronic air cleaner 100 at the active filter media 1020 and exits at the passive filter media 1030. This arrangement may protect the passive filter media 1030 since some filtering is first done by the active filter media 1020. In some implementations, this may extend the life of the passive filter media 1030.

The active filter media 1020 may be constructed of a polarizable material. In some implementations, the active filter media 1020 may be constructed of glass fibers. The active filter media 1020 may be used to primarily filter out small particles from the air. For example, the active filter media 1020 may filter out particles that are less than 0.3 microns in size. Put differently, the active filter media 1020 may filter out particles that are between 0.001 and 0.299 microns in size. The active filter media 1020 may be a non-pleated filter media.

The passive filter media 1030 may be constructed of a non-polarizing material. In at least some implementations, the passive filter media 1030 may be a synthetic material. In at least some implementations, the passive filter media 1030 may be constructed of a nanofiber material. For example, the passive filter media 1030 may be constructed of fibers in the range of 100 nm to 200 nm or, in some implementations, fibers in the range of 100 nm to 1000 nm. The passive filter media 1030 may be constructed of a three-dimensional network of stacked nanofibers. A nanofiber material, as used herein, may refer to a nano-engineered material. Such materials may be engineered to have consistent holes or spaces. That is, the nanofiber material may be nano-engineered to be more uniform in structure than traditional filter materials, which tend to have inconsistent holes and space.

In at least some implementations, the passive filter media 1030 may be constructed of a pleated material. For example, the passive filter media 1030 may be constructed of a pleated nanofiber material. The pleating may reduce the resistance of the passive filter media 1030 to airflow.

The passive filter media 1030 may be generally configured to collect particles above 0.3 microns. For example, the passive filter media 1030 may be configured to collect particles in the 0.3 to 10 micron range.

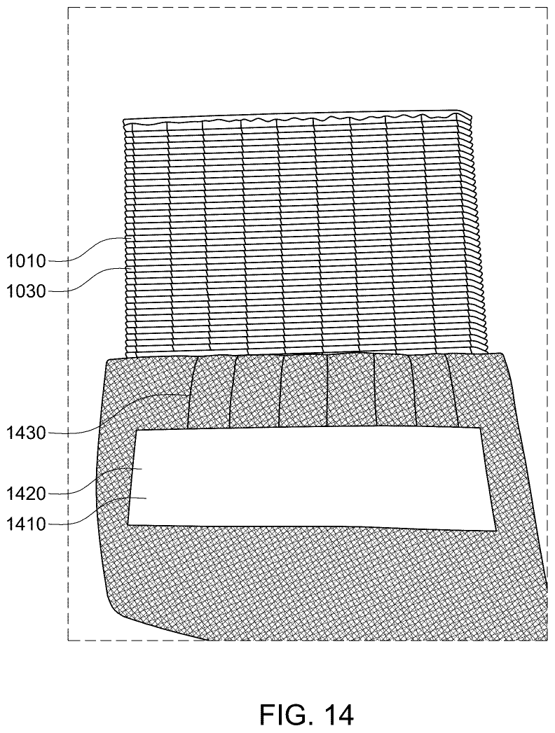

As noted above, the active filter media 1020 may be polarized. Such polarization may cause small particles to be agglomerated to allow such particles to become easier to trap on the active filter media 1020. Such polarization may be provided using a charge distribution grid 1410, such as the charge distribution grid 1410 illustrated in FIGS. 14 to 17.

The charge distribution grid 1410 may be physically attached to the active filter media 1020 at a surface of the active filter media 1020. The charge distribution grid 1410 may include a charge distribution strip 1420, which may be a carbonaceous strip. The charge distribution grid 1410 may include one or more filaments 1430. The filaments 1430 are in contact with the charge distribution strip 1420. In the illustrated example, the filaments are arranged as a series of parallel strands. In the illustrated example, each filament extends perpendicularly from the charge distribution strip 1420. The filaments 1430 are conductive.

The filaments may be constructed of a cotton string that is impregnated with a conductive coating, such as a graphite coating, to make them conductive. The coating may be, for example, a graphite paint. The graphite paint may be diluted with isopropyl alcohol to reduce the viscosity of the graphite paint to better pass through the cotton strands of the cotton string. A water-based lubricant could be used in some implementations in place of isopropyl alcohol, but a water-based lubricant may increase drying time as compared with an alcohol-based dilutant.

The conductive filaments that may be provided on the active filter media may be for distributing a charge from one location of the active filter media to another location of the active filter media. For example, the conductive filaments may be for distributing a charge from a region of the active filter media that is aligned with a probe or bar when the active filter media is in the filter housing to another region of the active filter media. Put differently, it may be for distributing a charge from a region of the active filter media associated with a second pleated part 2330 to a region of the active filter media associated with a first pleated part 2320. The active filter media may be associated with such regions by being aligned with such regions.

The charge distribution grid 1410 may be attached to the active filter media 1020 with an adhesive. The charge distribution grid may be attached to the active filter media 1020 at an interior side of the active filter media 1020. Put differently, the charge distribution grid 1410 may be attached at a side of the active filter media 1020 that is in contact with the passive filter media 1030. The charge distribution grid 1410 may be situated between the active filter media 1020 and the passive filter media 1030.

The active filter media 1020 and the passive filter media 1030 may be attached together; for example, with an adhesive. In at least some implementations, the attachment may be only at a portion of the active filter media 1020 and the passive filter media 1030. For example, the active filter media 1020 and the passive filter media 1030 may be attached at respective lower ends of the active and passive filter medias 1020, 1030. An upper end to the active filter media 1020, which may be the end at which the charge distribution strip 1420 is situated, may not be attached to the passive filter media 1030. For example, the upper end of the active filter media 1020 may, as illustrated in FIGS. 14, 15 and 17, be bendable back away from the passive filter media 1030. This may allow for insertion of a probe 1710, or bar, that is provided on one of the parts of the filtering housing 110 between the active filter media 1020 and passive filter media 1030. More specifically, the probe 1710 may be inserted between the filter medias 1020, 1030 so that it contacts the charge distribution strip 1420. This allows an electrical charge to be transferred to the charge distribution strip 1420 to charge the active filter media 1020 and the charge distribution grid 1410.

The active filter media 1020 and the passive filter media 1030 may be attached together with an adhesive that is applied only at the ends of the filter medias 1020, 1030 that are not associated with the charge distribution strip 1420. Accordingly, the active filter media 1020 and the passive filter media 1030 may be attached together at only one end, which is the end that does not extend the charge laterally across a surface of the active filter media 1020.

In some alternative embodiments, the active filter media 1020 and the passive filter media 1030 may not be attached. Instead, the filter medias may be separate so that they may be independently replaced if they are found to wear at different rates. For example, in some environments, the active filter media 1020 may be replaced more frequently than the passive filter media 1030.

The probe 1710 is a conductive probe. The probe 1710 may be a wire. The probe 1710 may be generally coated with a non-conducting sleeve or sheath, but it has an at least an exposed portion, such as an end that is not coated with the non-conducting sleeve. This exposed portion, such as the end, contacts the charge distribution strip 1420. The end may be bent towards the charge distribution strip 1420 so that it contacts the charge distribution strip. The end of the probe 1710 may contact the charge distribution strip 1420 when the filter media 1010 is inserted into the filter housing 110. The end of the probe 1710 may contact the charge distribution strip 1420 in a substantially perpendicular orientation. For example, the end of the probe may be oriented at an angle or between 80 to 100 degrees relative to a plane of a surface of the charge distribution strip 1420.

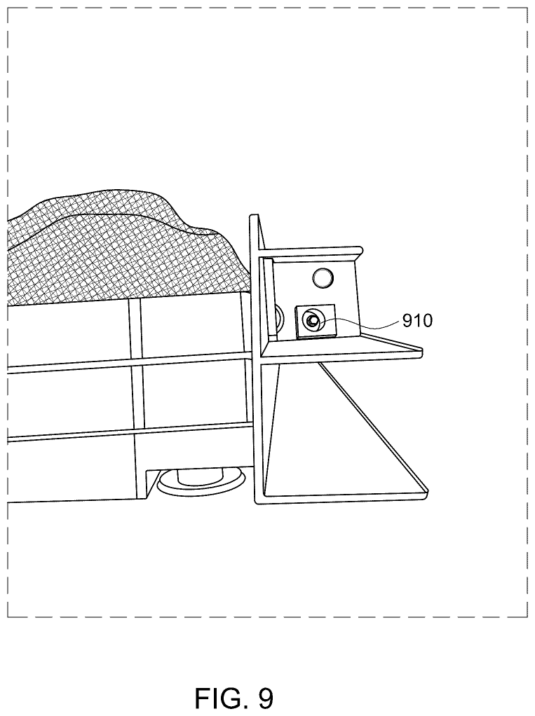

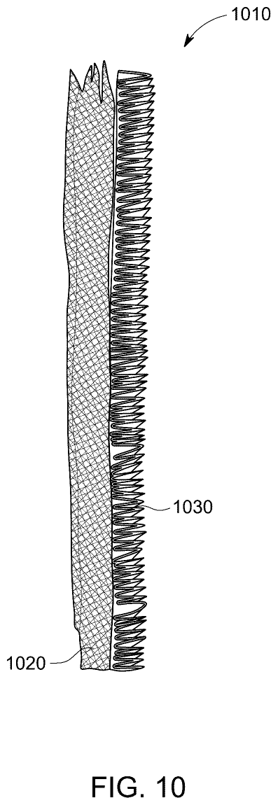

The probe 1710 may be coupled with a power supply. For example, the filter housing 110 may include an electrical power supply connection 910 (FIG. 9) which connects to a mains power supply. The connection may be via a transformer which steps down the mains power supply to a lesser voltage, such as 24 volts.

A filter housing 110 that includes a probe 1710 of the type described herein may be referred to as a probe-style filter or a probe-style filter housing.

In at least some implementations, the filter housing 110 may be connected with an electrical ground associated with the power supply.

To prevent the filter housing 110 from inadvertently becoming charged due to contact with the probe 1710, the filter housing 110 may include a non-conducting probe guard 450 (FIGS. 4 and 6 and 8). The probe guard 450 may be provided on a portion of the filter housing 110 that is generally associated with the active filter media 1020. The probe guard 450 may be constructed of plastic in some implementations. The probe guard 450 may be placed on an interior side of the first part 410 of the filter housing 110 of the electronic air cleaner 100. The probe guard 450 may be attached to the first part 410 with an adhesive, for example.

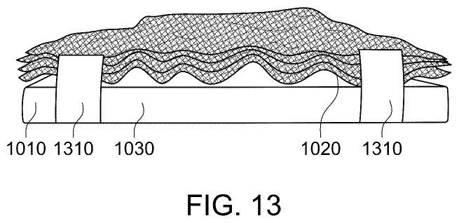

The filter media 1010 may include one or more tabs 1310, an example of which is illustrated in FIG. 13. The tabs 1310 may be attached to the passive filter media 1030. For example, the tabs 1310 may be attached to the passive filter media 1030 with an adhesive. The tabs 1310 may be attached to the passive filter media 1030 at an end. The tabs 1310 may extend upward from the passive filter media 1030 so that at least a portion of the tabs 1310 are aligned with the active filter media 1020. That is, the tabs may protrude above the pleated passive filter media to a region associated with the non-pleated active filter media. The tabs 1310 are not, however, directly attached to the active filter media 1020. Since the active filter media is compressible, the tabs 1310 may be engaged by a user. The tabs are, in some implementations, plastic tabs. The tabs may be formed of a thin plastic sheet, for example. The tabs may be used to facilitate removal of the pleased passive filter media from the air filter housing.

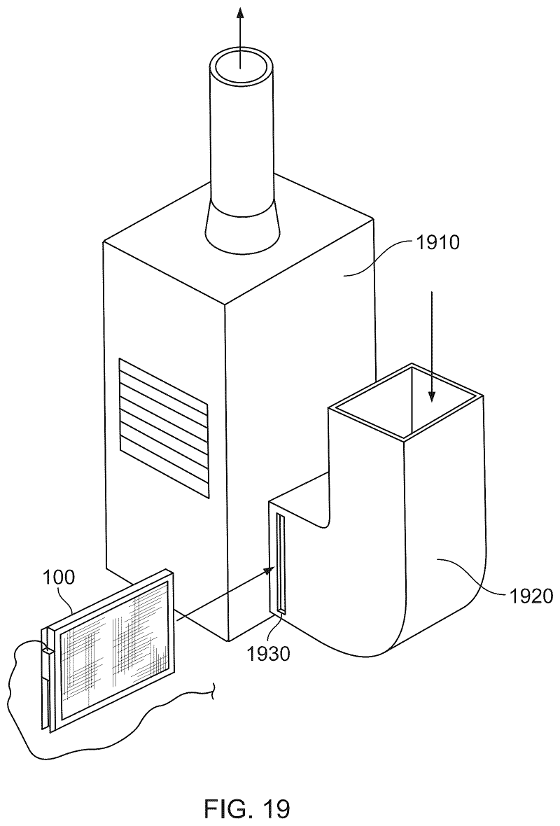

Accordingly, a two-part filter media 1010 as described herein may be used to provide both active and passive filtering. The two-part filter media 1010 may be used in a filter housing 110 such as the type described herein. The filter housing 110 and the two-part filter media 1010 may, together, form an electronic air cleaner 100. As illustrated in FIG. 19, the electronic air cleaner 100 may be sized for placement in a forced air system 1910, such as a heating, ventilation, and air conditioning (HVAC) system. By way of example, an electronic air cleaner of a type described herein may be mounted in a stream of air flowing through a cold air return duct 1920 of a conventional forced air furnace. For example, the forced air system 1910, or other ventilation system may include a housing defining a slot 1930 for receiving an air filter. The slot 1930 may be sized to receive an electronic air cleaner 100 of a type described herein. The electronic air cleaner, which may also be referred to as an air filter, may be situated within the slot. The air filter may be situated to allow the non-pleated active filter media to form an inlet side of the air filter and the pleated passive filter media to form an outlet side of the air filter. In this way, the air filter is arranged to protect the passive filter media by placing it downstream relative to the airflow.

The filter media 1010, which is also known as an air filter consumable, may be constructed using a method. An example method of constructing the filter media 1010 will now be described. The air filter consumable may be manufactured to accommodate charge distribution features, such as the probe 1710 or a conductive bar, associated with a filter housing. The manufacturing of the filter media 3210 includes manufacturing or providing a passive filter media 1030 and an active filter media 1020.

The passive filter media 1030 of the type described above may be prepared for use with the filter media 1010. This may include pleating the passive filter media 1030 using a pleating technique. Prior to the pleating, the passive filter media 1030 may be provided in roll or sheet form and may be generally flat. After pleating, the passive filter media 1030 has a pleated profile such as an accordion-style profile. By way of example, a knife pleating machine may be used to add a pleated feature to the passive filter media 1030.

The pleating may be maintained using an adhesive, such as a glue. The glue may be applied at intervals. For example, the glue may be applied at consistent spacing, such as, for example, at a spacing of between 0.5 and 1.5 inches. The glue may be applied in a strip across a pleat depth associated with a pleat. The glue may be a low heat glue that cures at a temperature that does not cause the nanofiber material to deteriorate. Conveniently, by using a glue-based structure to hold the pleating in place rather than a wire frame pleating technique, the risk of electrification of the passive filter media 1030 is reduced. That is, the glue-based pleating technique allows the passive filter media 1030 to remain generally non-conductive.

The passive filter media 1030 may be cut to a size that corresponds to the size of an internal cavity of the filter housing 110. For example, it may be cut to a size to fit snuggly within a cavity of the filter housing 110. In at least some implementations, a tab 1310 of the type described above may be attached to the passive filter media 1030; for example, with an adhesive.

An active filter media 1020 of the type described herein, such as a glass fiber sheet, may also be cut to a size that corresponds to the size of the internal cavity of the filter housing 110. The active filter media 1020 and the passive filter media 1030 may be a common size. That is, they may have a common length and width.

In at least some implementations, the method of constructing the filter media 1010 may include preparing the filaments. This may include coating strings with a conductive coating such as a graphite paint. The filaments may then be allowed to dry before proceeding to other steps of the method.

The method of constructing the filter media 1010 may include attaching the charge distribution grid 1410 to the active filter media 1020. The charge distribution grid 1410 may be attached to the active filter media 1020 with an adhesive. The charge distribution grid 1410 may be of a type described above. For example, the charge distribution grid 1410 may include the filaments 1430, which may be attached to the active filter media 1020 with the adhesive. This may be the same type of adhesive used in the pleating or it may be a different type of adhesive. The charge distribution grid 1410 may, in some implementations, include the charge distribution strip 1420, which may distribute charge laterally to each of the filaments 1430. The charge distribution strip 1420 may be applied generally perpendicular to the filaments 1430 and it may contact each of the filaments 1430. The charge distribution strip 1420 may be attached at a region that is associated with the probe 1710 when the filter media 1010 is used in a probe-style filter and/or in a region that is associated with a bar when the filter media 1010 is used in a bar-style filter. Accordingly, the method of constructing the filter media may include coupling conductive filaments to a surface of the active filter media with an adhesive. The conductive filaments are configured for distributing a charge across the surface of the active filter media.

In at least some implementations, the charge distribution grid 1410 may be allowed to cure on the active filter media 1020 before further processing of the active filter media 1020. For example, the adhesive may be allowed to dry before a next step.

The active filter media 1020 may then be attached to the passive filter media 1030. These filter medias may be of types described herein. In at least some implementations, the active filter media 1020 may be coupled to the passive filter media 1030 with an adhesive. The adhesive may be applied only at a lower end of the active filter media 1020 and/or a lower end of the passive filter media 1030. That is, an upper end of the passive filter media 1030 and an upper end of the active filter media 1020 may not be attached together with the adhesive. Instead, the upper end may remain detached so that they may be moved away from one another to allow for easy insertion of the probe 1710 (FIG. 17) or bar as the case may be. The upper end may be an end associated with the charge distribution strip 1420. Accordingly, the charge distribution strip 1420, where there is one, may not be attached to the passive filter media 1030; it may be attached to only the active filter media 1020. For filter media that is intended for only compatibility with a bar-style filter housing, the charge distribution strip 1420 may be omitted in some implementations.

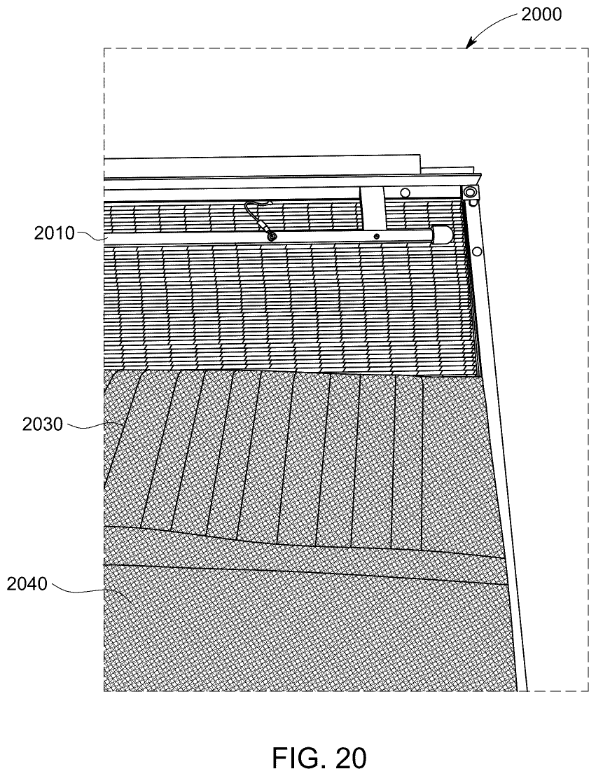

Variations to the embodiments described above are contemplated. For example, in some implementations, the probe 1710 may be formed as a bar or replaced with a bar. An example air cleaner 2000 having a bar 2010 is illustrated in FIG. 20. The air cleaner 2000 may be similar to the electronic air cleaner 100 described above, except it may use a bar instead of a wire-based probe. Accordingly, the air cleaner 2000 of FIG. 20 may also be referred to as an electronic air cleaner 100 and it may have features described above with reference to the probe-style filter housing.

The bar 2010 may be an elongate bar. The bar 2010 is constructed of a conductive material, such as a metal. The bar 2010 extends laterally and may distribute charge to the filaments 2030, which may be of the type described above. That is, the bar 2010 may be used to perform a function similar to the charge distribution strip 1420, except that it is attached to the housing 2110 rather than provided on or in the filter media. That is, while the charge distribution strip 1420 forms part of the consumable, the bar 2010 does not. The bar 2010 is energized from the power source and the bar 2010 may act similar to the charge distribution strip 1420, distributing charge to each of the filaments 2030. The filter media 2040 that is used with the air cleaner 2000 of FIG. 20 may be the same or a modified version of the filter media 1010 described above. For example, in one implementation, such as that illustrated in FIG. 20, the filter media 2040 may be modified to exclude the charge distribution strip 1420 since the charge distribution strip 1420 may not be required since the bar 2010 acts as a charge distribution strip.

A filter having a bar 2010 may be referred to as a bar-style filter or a bar-style filter housing.

Similar to the filter media 1010 described above with reference to FIGS. 10 to 18, the filter media 2040 of FIG. 20 may include charge distribution features. In some embodiments (not shown in FIG. 20), the filter media 2040 may include a charge distribution strip 1420 even where the air cleaner 2000 includes a bar that also acts as a charge distribution strip. The charge distribution strip 1420 may be positioned on the filter media to align with the bar 2010 when the filter media is inserted into the filter housing. This may allow a common filter media 2040 to work with both probe-style and bar-style filters. In some implementations, a size of the charge distribution strip 1420 may correspond to a size of the bar. For example, the heights and lengths may be approximately the same; for example, within 5% or, in some cases, 15%. The charge distribution strip 1420 may increase the probability of a proper charge being maintained and distributed. If, for example, the bar 2010 becomes coated in aluminum oxide through galvanic corrosion or other causes, the charge distribution strip 1420 may aid in distributing charge. For example, as long as a small portion of the bar 2010 remains oxide-free, the bar 2010 may transmit charge to the charge distribution strip 1420 which may then transmit the charge to the filaments.

In another variation, the filter media may have multiple charge distribution strips 1420. For example, the filter media may have multiple carbonaceous strips. Each of the charge distribution strips may contact each of the filaments and may distribute charge to each filament. Multiple charge distribution strips increases the probability that all areas of all filaments will receive the maximum amount of voltage.

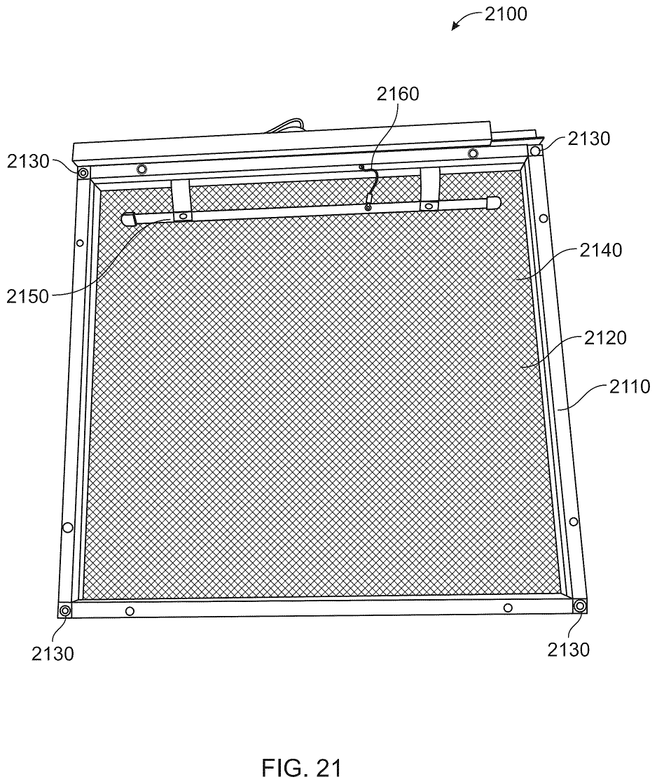

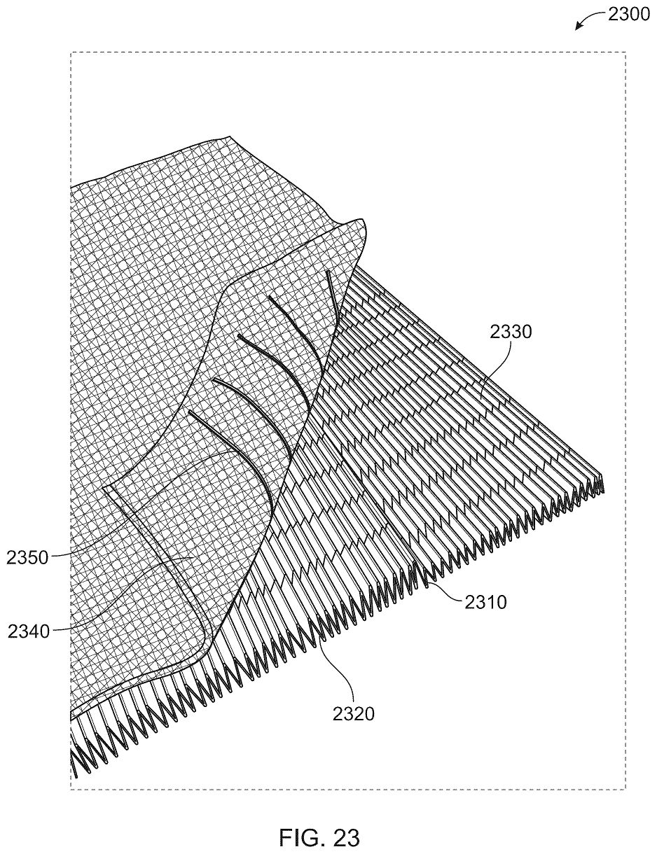

Other embodiments of an electronic air cleaner are contemplated. For example, an electronic air cleaner 2100 is illustrated in FIGS. 21 to 31. This electronic air cleaner 2100 is similar to the example air cleaner 2000 having a bar 2010 illustrated in FIG. 20. The electronic air cleaner 2100 is capable of providing concurrent active and passive filtering of air. The electronic air cleaner 2100 is another example of the electronic air cleaner 100 of FIG. 1, and as such is similarly rectangular shaped and may have exterior dimensions that are sized to allow the filter to fit within a filter slot or compartment of a forced air system. Similar to the electronic air cleaner 100 in FIG. 1 to 9, the electronic air cleaner 2100 may include a filter housing 2110 which may be used to house the filter media 2300 as illustrated in FIGS. 23 to 26. The filter housing 2110 may define a cavity 2120 which receives the filter media 2300 within the cavity 2120.

In some embodiments, the filter housing 2110 may be two-part. For example, the filter housing may include a first part 2140 with a first face and a second part with a second face which together hold the filter media 2300 within the cavity 2120 of the filter housing 2110. In some cases, the first part 2140 and the second part may be substantially identical and fasten onto the opposite sides of the filter housing 2110. In another case, the first face of the first part 2140 and the second face of the second part may each constitute a panel composed of a steel-linked cage. In some embodiments, the first face and second face may be referred to as screens or grills. In some embodiments, the first part 2140 may be detachable from the second part. In some cases, the first part 2140 is completely detachable from the second part. The first part 2140 and the second part may be connected to one another using fasteners fastened into slots 2130 (similar to the ones in FIG. 4) which may be situated at respective corners of the filter housing 2110. For example, snap tabs may be used to connect the parts to one another at respective corners. One of the parts, such as the first part 2140, may have, at its corners, respective fasteners, such as tabs, which may be pushed in the direction of the second part in order to couple the parts together or it may be pulled in the opposite direction to detach the parts from one another. One or more of the parts may have slots 2130 for receiving the fasteners. For example, the first part 2140 may have the fasteners and the second part may have the slots 2130. The fasteners and the slots 2130 may have mating features, such as corresponding ridges and recesses or protrusions and voids, which allow the fasteners and slots 2130 to snap together. Once coupled together, the fasteners may be removed by applying a force to decouple the mating features.

A latch, clasp or other mechanism may maintain the filter housing 2110 in a closed position, and it may be disengaged in order to allow the filter housing 2110 to be opened to remove or insert the filter media 2300. In some embodiments, a clasp may be engaged to maintain the filter housing 2110 in the closed position by preventing movement of the hinge. The clasp may be disengaged to allow the filter housing 2110 to be opened, to allow for the filter media 2300 to be placed in or removed from the cavity 2120 of the filter housing 2110. The filter housing 2110 may be constructed of a rigid material, which in some cases may be metal such as aluminum or light-weight steel. In some cases, the filter housing 2110 has a thickness of two inches. In some cases, the filter housing 2110 has a thickness of three inches. In some cases, the filter housing 2110 has a thickness of four inches. In some cases, the filter housing 2110 has a thickness of five inches. In some cases, the filter housing 2110 may have a thickness that allows it to hold a filter media 2300 within the cavity 2120. The filter housing 110 of FIGS. 1 to 9 may have any features described herein with reference to the filter housing 2110 of FIG. 21, and vice versa.

In some embodiments, the filter housing 2110 has a bar 2150 attached to the first part 2140. In some embodiments, the bar 2150 takes the form of a bar which extends laterally and which is attached to the first part 2140. The bar 2150 may be attached to the first part 2140 of the filter housing 2110 through a clasp, fasteners or some other attachment mechanism. The attachment mechanism may be formed from a non-conductive material, such as plastic or rubber. The bar 2150 rests in the cavity 2120 of the filter housing 2110.

In some embodiments, a wire 2160 connects the bar 2150 to the first part 2140 of the filter housing 2110, passing an electrical charge onto the bar 2150. The bar 2150 may be a conductive bar, formed from a conductive material. Some sides of the bar 2150, which may not come into contact with the filter media 2300 when inserted into the cavity 2120 of the filter housing 2110, may be constructed or covered by non-conductive material. In some cases, the ends of the bar 2150 may also be constructed or covered by non-conductive material. The bar 2150 may be coupled with a power supply through the wire 2160. For example, the filter housing 2110 may include an electrical power supply connection, similar to the electrical power supply connection 910 from FIG. 9, from which the wire 2160 connects from and which connects to a mains power supply. The connection may be via a transformer which steps down the mains power supply to a lesser voltage, such as 24 volts. In at least some implementations, the filter housing 2110 may be connected with an electrical ground associated with the power supply.

The filter media 2300 (illustrated in FIGS. 23 to 26) may also be referred to as a filter pad, a hybrid pad, a hybrid pad set, an air filter consumable configured for accommodating charge distribution, a filter or a pad. The filter media 2300 may be similar to the filter media previously disclosed. The filter media 2300 may be a multi-material filter media. The filter media 2300 may include both active filter media 2340 and passive filter media 2310. The active filter media 2340 may be used as an upstream filter media. That is, the active filter media 2340 may be situated at an inlet side of the filter housing 2110. The passive filter media 2310 may be used as a downstream filter media. That is, the passive filter media may be situated at an outlet side of the filter housing 2110. That is, the active filter media 2340 may be situated within the filter housing 2110 so that it is relatively more upstream than the passive filter media 2310. Put differently, the filter media 2300 is situated so that incoming air flow enters the electronic air cleaner 2100 at the active filter media 2340 and exits at the passive filter media 2310. This arrangement may protect the passive filter media 2310 since some filtering is first done by the active filter media 2340. In some implementations, this may extend the life of the passive filter media 2310.

In some embodiments, the filter media 2300 has the passive filter media 2310 coupled with the active filter media 2340 using an adhesive. In some embodiments, the adhesive is applied to couple the passive filter media 2310 to the active filter media 2340 at only a portion of a surface of each of the passive filter media 2310 and the active filter media 2340. In this way, an uncoupled region of the active filter media 2340 may be movable relative to the passive filter media 2310.

The active filter media 2340 may be constructed of a polarizable material. In some cases, the active filter media 2340 may be comprised of a dielectric filter medium. In some embodiments, the dielectric filter medium may be a permeable glass pad. In some implementations, the active filter media 2340 may be constructed of glass fibers. In some cases, the active filter media 2340 is a non-pleated active filter media. The active filter media 2340 may be used to primarily filter out small particles from the air. For example, the active filter media 2340 may filter out particles that are less than 0.3 microns in size. Put differently, the active filter media 1020 may filter out particles that are between 0.001 and 0.299 microns in size. The active filter media 2340 may be a non-pleated filter media. In some embodiments, conductive filaments are adhesively coupled to the active filter media 2340. These conductive filaments may be as described above. For example, they may be configured for distributing a charge across the surface of the active filter media 2340.

The passive filter media 2310 may be constructed of a non-polarizing material. In at least some implementations, the passive filter media is a non-conductive air-permeable pleated filtering mediums. In at least some implementations, the passive filter media 2310 may be a synthetic material. In at least some implementations, the passive filter media 2310 may be constructed of a nanofiber material. The nanofiber material may be of a type described above. The passive filter media 2310 may be constructed of fibers in the range of 100 nm to 200 nm or, in some implementations, fibers in the range of 100 nm to 1000 nm. The passive filter media 2310 may be constructed of a three-dimensional network of stacked nanofibers. In some embodiments, the passive filter media 2310 is constructed of a nano-engineered material configured to collect particles 10 microns or less in size. The passive filter media 2310 may be constructed from a nano-engineered material which has a grid-like structure. For example, the passive filter media 2310 may be constructed from a nano-engineered material that has a uniform grid-like structure under a microscope. The grid-like structure may be substantially uniform. The nano-engineered material may have a substantially uniform structure under microscope.

In some embodiments, the passive filter media 2310 may be constructed of a pleated material. In some cases, the passive filter media 3290 is a pleated passive filter media. For example, the passive filter media 2310 may be constructed of a pleated nanofiber material. The pleating may reduce the resistance of the passive filter media 2310 to airflow. In some embodiments, the passive filter media 2310 is pleated using a gluing technique in which an adhesive bonds adjacent pleats together at intervals. This technique may be as described above. In some embodiments, the passive filter media 3290 comprises two pleated regions which may be referred to as pleated parts. The passive filter media 2310 may be constructed of a first pleated part 2320, also called a first filtering region, and a second pleated part 2330, also called a second filtering region. The first pleated part 2320 may have a different loft height than the second pleated part 2330. That is, the first pleated part 2320 may have a different thickness than the second pleated part 2330. Put differently, the first pleated part 2320 may have a different pleat depth than the second pleated part 2330. By way of example, in at least some implementations, the second pleated part 2330 has a loft that is at least one centimeter less than the loft of the first filtering region.

The first pleated part 2320 and the second pleated part 2330 are both pleated regions. They may be formed using the gluing technique described herein. For example, they may be formed using a gluing technique in which an adhesive bonds adjacent pleats together at intervals.

In some embodiments, the second pleated part 2330 may have a relatively thinner loft than the first pleated part 2320. In some embodiments, the first pleated part 2320 and the second pleated part 2330 are attached together, utilizing an adhesive or some other attaching mechanism. These pleated parts may be attached across respective ends. These ends may have a common length, but a different height. The pleated parts may be attached at a single one of the pleatings for each of the parts.

Accordingly, the second pleated part 2330 may have a loft height that is relatively thinner than the loft height of the first pleated part 2320. The loft height of the second pleated part 2330 may be of a height to allow the second pleated part 2330 to easily slide under the bar 2150 (or probe as the case may be), when the filter media 2300 is placed in the cavity 2120 of the filter housing 2110.

In some embodiments, the loft height of the active filter media 2340 may be between a half of an inch (0.5″) to three quarters of an inch (0.75″). In some embodiments, the active filter media 2340 may have a uniform loft across its area. That is, the active filter media 2340 may have a uniform loft height. Put differently, the active filter media 2340 may have a uniform thickness.

In some embodiments, the loft height of the first pleated part 2320 of the passive filter media 2310 may be between three quarters of an inch (0.75″) to one and a half inch (1.5″). In some embodiments, the loft height of the second pleated part 2330 of the passive filter media 2310 may be between a half of an inch (0.5″) to three quarters of an inch (0.75″).

In some embodiments, the bar 2150 (or probe as the case may be) may have a thickness or height within the filter housing that equals or is less than the loft height difference between the loft height of the first pleated part 2320 and the loft height of the second pleated part 2330. In some embodiments, the bar 2150 may have a thickness or height within the filter housing which allows the second pleated part 2330 to slide underneath the bar 2150 while allowing the filter media to fit into the cavity 2120 of the filter housing 2110. In some embodiments, the second pleated part 2330 has a loft height that is at least one centimeter less than the loft height of the first pleated part 2320.

Conveniently, the techniques described herein may be used with very narrow filters, even as small as one inch filters. This allows for high-quality air filtering even where a ventilation system is configured with a small slot.

The active filter media 2340 and the passive filter media 2310 may be coupled with one another. In at least some implementations, this attachment or coupling may only be made at a first filtering region, such as the first pleated part 2320. That is, the second filtering region, such as the second pleated part 2330 may not be directly coupled to the passive filter media. Put differently, the attachment may be made only along the portion of the passive filter media 2310 that is relatively thicker than another portion of the passive filter media 2310. This allows a pocket to be formed in an area of the passive filter media 2310 associated with the thinner second filtering region. That is, the active filter media 2340 and the passive filter media 2310 define a pocket therebetween in an area associated with the second pleated part 2330. This pocket may be for accommodating charge distribution features, such as a bar or probe.

The active filter media 2340 may be relatively more compressible than the passive filter media 2310. As noted above, the active filter media 2340 may be constructed of glass fibers and may be soft and compressible. In contract, the passive filter media 2310, may be constructed of a pleated nanofiber material, and may be more rigid in structure.

In some embodiments, the filter media 2300, which includes the active filter media 2340 and passive filter media 2310, may be sized to concurrently fit within a one inch filter housing 2110. In some embodiments, the filter media 2300 may be sized to concurrently fit within a two inch filter housing 2110. In some embodiments, the filter media 2300 may be sized to concurrently fit within a three inch filter housing 2110. In some embodiments, the filter media 2300 may be sized to concurrently fit within a four inch filter housing 2110. In some embodiments, the filter media 2300 may be sized to concurrently fit within a five inch filter housing 2110. In some embodiments, the filter media 2300 may be sized to concurrently fit within the cavity 2120 of a filter housing 2110.

The electronic air cleaner 2100 may provide an improvement over at least some existing ventilation systems as it may allow for increased air filtration and filter performance in a compact filter housing. This may allow the electronic air cleaner to be deployed in various configurations in which existing ventilation systems would not be able to provide the same level of air filtration and filter performance. The electronic air cleaner presently disclosed may allow for increased passive and electronic air filtration for different particulate sizes in a filter system which is compact and compatible with existing HVAC systems.

As noted above, the active filter media 2340 may be polarized or polarizable. Such polarization may cause small particles to be agglomerated to allow such particles to become easier to trap on the active filter media 2340. Such polarization may be provided using a charge distribution grid 2350 which may be similar to the charge distribution grid described above. For example, the charge distribution grid 2350 may be physically attached to the active filter media 2340 at a surface of the active filter media 2340. The charge distribution grid 2350 may include one or more filaments, which may also be referred to as conductive filaments. The filaments may be in contact with the charge distribution grid 2350. In the illustrated example, the filaments may be arranged as a series of parallel strands. In the illustrated example, each filament extends parallel to other filaments in the charge distribution grid 2350. In some embodiments, the charge distribution grid 2350 may include a charge distribution strip, which may be a carbonaceous strip.

The filaments may be constructed as described above. For example, the filaments may be constructed of a cotton string that is impregnated with a conductive coating, such as a graphite coating, to make them conductive.

The charge distribution grid 2350 may be attached to the active filter media 2340 with an adhesive, as described above with reference to the charge distribution grid 1410 of FIGS. 14 to 17.

In some alternative embodiments, the active filter media 2340 and the passive filter media 2310 may not be attached. Instead, the filter medias may be separate so that they may be independently replaced if they are found to wear out at different rates. For example, in some environments, the active filter media 2340 may be replaced more frequently than the passive filter media 2310.

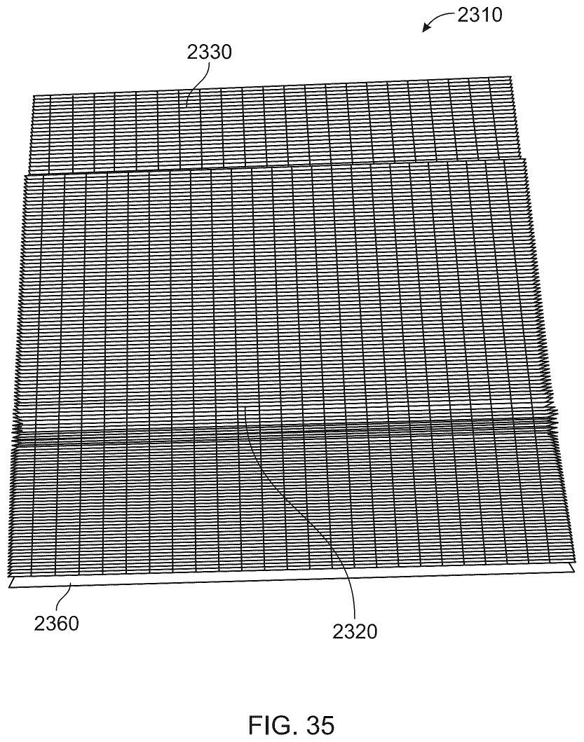

The filter media 2300 may include one or more tabs 2360 (an example is shown in FIG. 35). The tabs 2360 may be attached to the passive filter media 2310 during a method of manufacture; for example, in the manner described above with reference to the tabs 1310 of FIG. 13

In an embodiment, the electronic air cleaner 2100 may include a filter media 2300 in which the passive filter media 2310 and the active filter media 2340 are placed apart from each other in the filter housing 2110. In such an embodiment, the passive filter media 2310 and the active filter media 2340 may not be attached to each other with an adhesive, and instead are separated parts. In some cases, the passive filter media 2310 and the active filter media 2340 are placed apart within the filter housing 2110 to create a gap, vacuum or pocket in between the passive filter media 2310 and the active filter media 2340. Such an embodiment allows for the application of the passive filter media 2310 and the active filter media 2340 in a large filter housing 2110 which is not constrained by width, and allows for the application of the electronic air cleaner 2100 in existing ventilation ducts, pipes or systems.

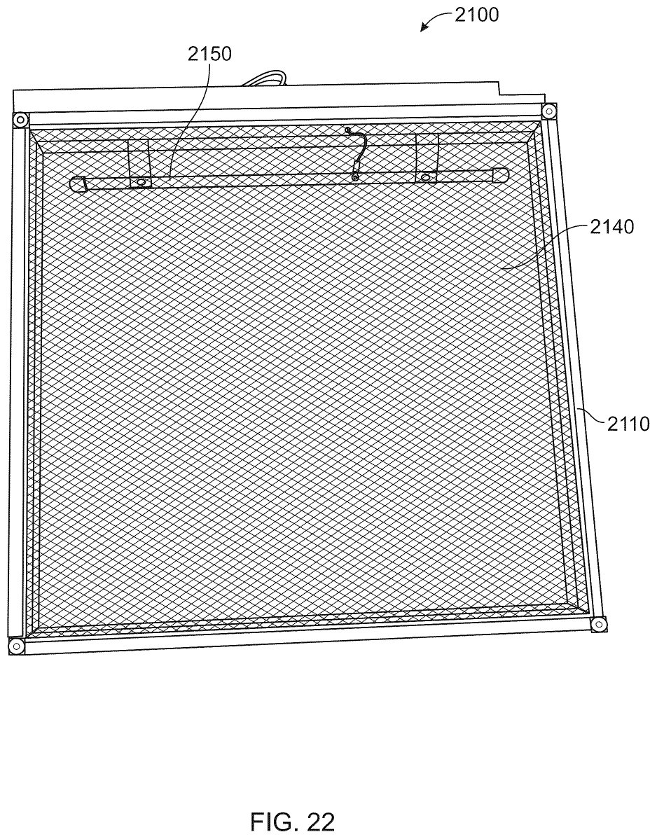

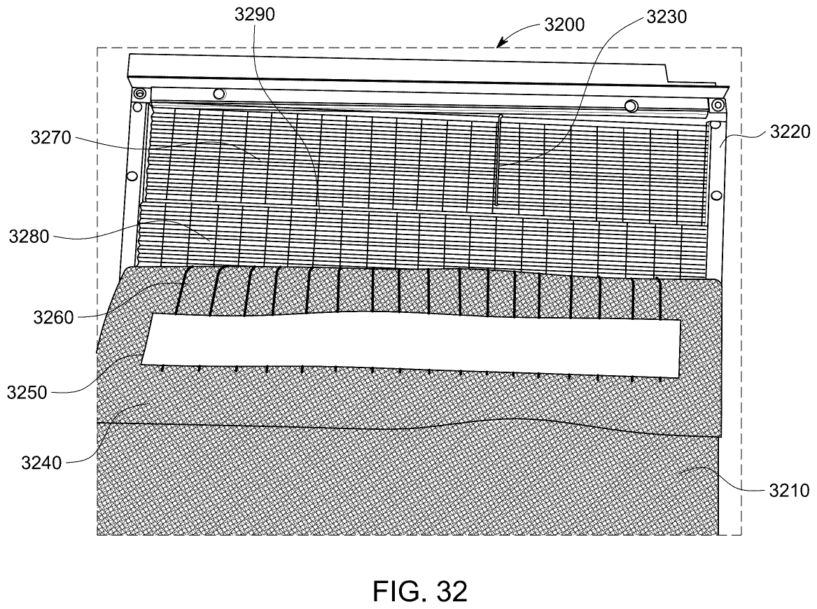

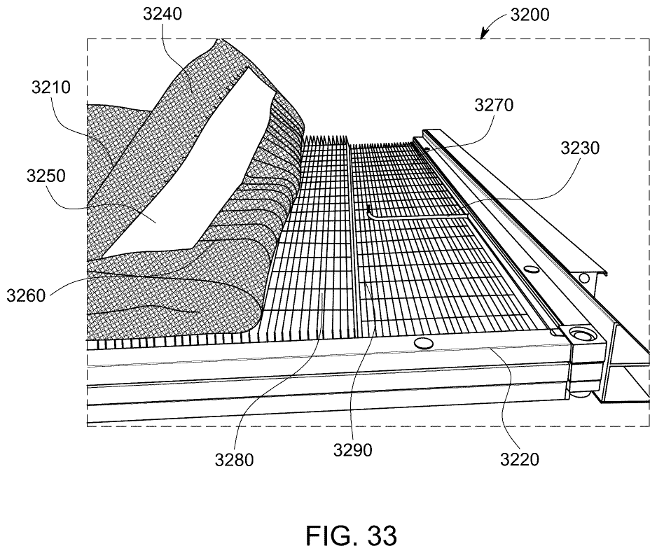

FIG. 32 and FIG. 33 illustrate another embodiment of an electronic air cleaner 3200. In this example, a multi-lofted passive filter of the type described above with reference to FIGS. 22 to 31 is used in a probe-style filter housing. The electronic air cleaner 3200 of FIGS. 32 and 33 includes a filter housing 3220 with a probe 3230. The electronic air cleaner 3200 includes a filter media 3210 with a charge distribution strip 3250 and a passive filter media 3290 with two parts with different loft heights. The electronic air cleaner 3200 is similar to the electronic air cleaner 2100 disclosed in FIG. 21.

The electronic air cleaner 3200 may include a two-part filter housing 3220, such as the type described above.

In some embodiments, a probe 3230 is attached to and/or provided in or by the filter housing 3220. The probe 3230 is a conductive probe and may be of the type described above; for example, with reference to FIGS. 1 to 7.

The filter media 3210, which may also be referred to as an air filter consumable may be inserted into the cavity of s filter housing 3220. The filter media 3210 may be configured for accommodating charge distribution features associated with an air filter housing. The filter media 3210 is similar to the filter media 2300 disclosed in FIGS. 23 to 26. The filter media 3210 includes two parts: a passive filter media 3290 and an active filter media 3240. The active filter media 3240 may be a non-pleated active filter media. The passive filter media 3290 may be a pleated passive filter media. The active filter media 3290 may be of a type described above with reference to any of the FIGs. previously discussed.

In some embodiments, the filter media 3210 has the passive filter media 3290 coupled with the active filter media 3240 using an adhesive.

The passive filter media 3290 may be similar to or identical to the passive filter media 2310 disclosed in FIGS. 21 to 31. The passive filter media 3290 may have multiple parts with different loft heights. For example, the passive filter media 3290 may have two parts with two different loft heights. For example,
the passive filter media 3290 may have a first pleated part 3280 which has a different loft height than a second pleated part 3270. In some cases, the first pleated part 3280 has a greater loft height than the loft height of the second pleated part 3270. Put differently, the second pleated part 3270 may have a relatively thinner loft than the first pleated part 3280.

The manufacturing of the filter media 3210 of FIGS. 32 and 33 may be manufactured in the same manner as the filter media of FIG. 23. For example, one or both of the passive filter media 3290 and the active filter media 3240 may be manufactured or otherwise provided. In some embodiments, the passive filter media 3290 may be constructed of a pleated material or pleated materials. For example, the passive filter media 3290 may be constructed of a pleated nanofiber material. The pleating may reduce the resistance of the passive filter media 3290 to airflow. In some embodiments, the passive filter media 3290 is pleated using a gluing technique, such as techniques described herein. For example, the gluing technique may be one in which an adhesive bonds adjacent pleats together at intervals. In some embodiments, the passive filter media 3290 includes two pleated regions.

In some embodiments, the first pleated part 3280 and the second pleated part 3270 are planar at one surface. For example, a filtering surface of the first pleated part 3280 may be generally aligned along a common plane with a filtering surface of the second pleated part 3270. At an opposing side of the first pleated part 3280 and the second pleated part 3270, the surfaces do not align with one another. Rather, they form a step. The passive filter media 2300 described above with reference to FIGS. 23 to 26 may have similar features or be similarly formed.

The first pleated part 3280 may also be referred to as a first filtering region and the second pleated part 3270 may also be referred to as a second filtering region. These filtering regions, together, form the passive filter media 3290. Each of these filtering regions may be non-conductive. Each of these regions may be air-permeable filtering mediums.

In some embodiments, the first pleated part 3280 and the second pleated part 3270 are coupled together during a method of manufacture, utilizing an adhesive or some other attaching mechanism. In some embodiments, the part of the first pleated part 3280 facing the active filter media 3240 and the part of the second pleated part 3270 facing the active filter media 3240 are perpendicular to the coupling region of the first pleated part 3280 and the second pleated part 3270.

The first pleated part 3280 and the second pleated part 3270 may be coupled together to that a first side of the first pleated part 3280 and a first side of the second pleated part 3270 are planar. The first side of the first pleated part 3280 and the first side of the second pleated part 3270 may be perpendicular to a coupling region of the first pleated part 3280 and the second pleated part 3270. The coupling region may be a region at which the respective parts are attached to one another.

Accordingly, a method of manufacture may include a step of coupling the first filtering region and the second filtering region and this step may include aligning a first side of the first filtering region and a first side of the second filtering region such that the first side of the first filtering region and the first side of the second filtering region are planar.

The first pleated part 3280 and the second pleated part 3270 may be coupled together to form a step at a point of contact between the first pleated part 3280 and the second pleated part 3270. More specifically, a second side of the first pleated part 3280 and a second side of the second pleated part 3270 may be non-planar. These second sides may, instead, form a step. Accordingly, a method of manufacturing an air filter consumable may include a coupling step in which the first filtering region and the second filtering region are coupled to one another and this coupling step may include forming a step at a point of contact between the first filtering region and the second filtering region.

In some embodiments, the loft height of the second pleated part 3270 may be of a height to allow the second pleated part 3270 to slide under the probe 3230 (or bar), when the filter media 3210 is placed in the cavity of the filter housing 2110. In some embodiments, the probe 3230 may have a thickness which allows the second pleated part 3270 to slide underneath the probe 3230 while allowing the filter media to fit into the cavity of the filter housing 2110.

The second pleated part 3270, with its lower loft height than the first pleated part 3280, prevents the passive filter media 3290 from coming into contact with the charged probe 3230, allowing the electronic air cleaner to function. The lack of contact between the second pleated part 3270 and the charged probe 3230 is created by the pocket, vacuum, or gap created by the lower loft height of the second pleated part 3270 and the charged probe 3230. The second pleated part 3270, and the lack of contact with the probe 3230 may also reduce the chance of a malfunction related to the passive filter media 3290 becoming inadvertently charged by coming into contact with the probe 3230. The pocket created by the second pleated part 3270 and the probe 3230 help mitigate the issue of arcing of the probe which can lead to the unintended distribution of charges and polarization of the filter housing. The pocket may allow the passive filter media 3290 and the active filter media 3240 to function optimally.

The active filter media 3240 may be of the type described above including, with reference to FIG. 10 and the active filter media 1020.

The active filter media 3240 is polarized or polarizable, similar to the active filter media 1020 of FIG. 10. Such polarization may be provided using a charge distribution grid 3260, which may be of a type described above. The charge distribution grid 3260 may be physically attached to the active filter media 3240 at a surface of the active filter media 3240. The charge distribution grid 3260 may include a charge distribution strip 3250, which may be a carbonaceous strip. The charge distribution grid 3260 may include one or more filaments. The filaments are in contact with the charge distribution strip 3250. In the illustrated example, the filaments are arranged as a series of parallel strands. In the illustrated example, each filament extends perpendicularly from the charge distribution strip 3250. The conductive filaments are for distributing a charge across the surface of the non-pleated active filter media 3240. The conductive filaments may be coupled to a surface of the active filter media with an adhesive.

The filaments may be constructed as described above.

An active filter media 3240 of the type described herein, such as a glass fiber sheet, may also be cut to a size that corresponds to the size of the internal cavity of the filter housing 3220. The active filter media 3240 and the passive filter media 3290 may be a common size. In at least some implementations, the method of constructing the filter media 3210 may include preparing the filaments. This may include coating strings with a conductive coating such as a graphite paint. The filaments may then be allowed to dry before proceeding to other steps of the method.

The method of constructing the filter media 3210 may include attaching the charge distribution grid 3260 to the active filter media 3240. The charge distribution grid 3260 may be attached to the active filter media 3240 with an adhesive. The charge distribution grid 3260 may be of a type described above. In at least some implementations, the charge distribution grid 3260 may be allowed to cure on the active filter media 3240 before further processing of the active filter media 3240. For example, the adhesive may be allowed to dry before a next operation.

The active filter media 3240 may then be attached to the passive filter media 3290. In at least some implementations, the active filter media 3240 may then be attached to the passive filter media 3290 with an adhesive. The adhesive may be applied only at a lower end of the active filter media 3240 and a lower end of the passive filter media 3290. That is, an upper end of the passive filter media 3290 and an upper end of the active filter media 3240 may not be attached together with the adhesive. Instead, the upper end may remain detached so that they may be moved away from one another to allow for easy insertion of the probe 3230. The upper end may be an end associated with the charge distribution strip 3250. Accordingly, the charge distribution strip 3250 may not be attached to the passive filter media 3290; it may be attached to only the active filter media 3240.

The above discussed embodiments are considered to be illustrative and not restrictive. Certain adaptations and modifications of the described embodiments may be made. All such modification, permutations and combinations are intended to fall within the scope of the present disclosure.

What is claimed is:

1. An air filter consumable configured for accommodating charge distribution features associated with an air filter housing, the air filter consumable comprising:
a passive filter media comprising:
a first filtering region; and
a second filtering region having a relatively thinner loft than the first filtering region.

2. The air filter consumable of claim 1, wherein the first filtering region and the second filtering region are non-conductive air-permeable pleated filtering mediums.

3. The air filter consumable of claim 1, wherein the first filtering region and the second filtering region are coupled together with an adhesive.

4. The air filter consumable of claim 3, wherein the first filtering region and the second filtering region are coupled together such that a first side of the first filtering region and a first side of the second filtering region are planar, wherein the first side of the first filtering region and the first side of the second filtering region are perpendicular to a coupling region of the first filtering region and the second filtering region.

5. The air filter consumable of claim 4, wherein a second side of the first filtering region and a second side of the second filtering region form a step.

6. The air filter consumable of claim 1, further comprising:
an active filter media.

7. The air filter consumable of claim 6, wherein the active filter media has a uniform loft across its area.

8. The air filter consumable of claim 6, wherein the active filter media is a non-pleated filter media.

9. The air filter consumable of claim 8, wherein the active filter media comprises a dielectric filter medium.

10. The air filter consumable of claim 9, wherein the dielectric filter medium is a permeable glass pad.

11. The air filter consumable of claim 9, wherein the active filter media is coupled to the passive filter media with an adhesive at the first filtering region but not the second filtering region.

12. The air filter consumable of claim 11, wherein the active filter media includes conductive filaments for distributing a charge from a region of the active filter media associated with the second filtering region to a region of the active filter media associated with the first filtering region.

13. The air filter consumable of claim 6, wherein the active filter media is relatively more compressible than the passive filter media.

14. The air filter consumable of claim 6, wherein the active filter media and the passive filter media define a pocket therebetween in an area associated with the second filtering region, the pocket for accommodating the charge distribution features.

15. The air filter consumable of claim 6, wherein a loft height of the active filter media is between a half of an inch (0.5″) to three quarters of an inch (0.75″) and wherein a loft height of a second filtering region is between a half of an inch (0.5″) and three quarters of an inch (0.75″) and the loft height of the first filtering region is between three quarters of an inch (0.75″) to one and a half inch (1.5″).

16. The air filter consumable of claim 1, wherein the first filtering region and the second filtering region are pleated regions formed using a gluing technique in which an adhesive bonds adjacent pleats together at intervals.

17. The air filter consumable of claim 1, wherein the second filtering region has a loft that is at least one centimeter less than the loft of the first filtering region.

18. An air filter comprising:
an air filter housing defining a cavity;
the air filter consumable provided in the cavity, the air filter consumable configured for accommodating charge distribution features associated with the air filter housing, the air filter consumable comprising:
a passive filter media comprising:
a first filtering region; and
a second filtering region having a relatively thinner loft than the first filtering region.

19. A method of manufacturing an air filter consumable, the method comprising:
preparing a passive filter media by coupling a first filtering region to a second filtering region with an adhesive, the second filtering region having a relatively thinner loft than the first filtering region.

20. The method of claim 19, wherein coupling the first filtering region and the second filtering region includes aligning a first side of the first filtering region and a first side of the second filtering region such that the first side of the first filtering region and the first side of the second filtering region are planar, and wherein the first side of the first filtering region and the first side of the second filtering region are perpendicular to a coupling region of the first filtering region and the second filtering region.
